(19) United States
(12) Patent Application Publication
(10) Pub. No.: US 2026/0178281 A1
(43) Pub. Date: Jun. 25, 2026

(54) RETRIEVAL-AUGMENTED TEMPLATE GENERATION IN SOFTWARE PLATFORMS

(71) Applicant: ATLASSIAN PTY LTD, Sydney (AU)

(72) Inventors: Bhavya Narang, Bengaluru (IN); . Mrigank, Bengaluru (IN); Yashasvi Galav, Bengaluru (IN); . Abhishek, Bengaluru (IN)

(21) Appl. No.: 19/000,318

(22) Filed: Dec. 23, 2024

(51) Int. Cl. G06F 8/20

(52) U.S. Cl. CPC G06F 8/20

(57) ABSTRACT

Retrieval-augmented template generation is provided. One or more issue features of an input issue data object may be extracted in response to a response creation indication associated with the input issue data object. One or more similar issue data objects may be identified from one or more previous issue data objects based on the one or more issue features. One or more relevant knowledge documents may be identified from one or more knowledge documents based on the one or more issue features. A response template may be generated using a generative AI model and based on the input issue data object, the one or more similar issue data objects, and the one or more relevant knowledge documents. The response template may comprise a preconfigured issue title and a preconfigured issue response. Display of the response template may be caused in an issue tracking user interface.

### TECHNICAL FIELD

The present disclosure relates generally to response templates; particularly to retrieval-augmented template generation in software platforms such as issue tracking systems.

### BACKGROUND

Issue management is an essential aspect of software development and IT service management in a software application framework. Applicant has identified many deficiencies and problems associated with issue response process for responding to issues. Through applied effort, ingenuity, and innovation, these identified deficiencies and problems have been solved by developing solutions that are in accordance with the embodiments of the present invention, many examples of which are described in detail herein.

### BRIEF SUMMARY

In accordance with one aspect, a computer-implemented method for retrieval-augmented template generation is provided, the computer-implemented method comprising extracting one or more issue features of an input issue data object in response to a response creation indication associated with the input issue data object; identifying one or more similar issue data objects from one or more previous issue data objects based on the one or more issue features; identifying one or more relevant knowledge documents from one or more knowledge documents based on the one or more issue features; generating a response template using a generative AI model and based on the input issue data object, the one or more similar issue data objects, and the one or more relevant knowledge documents, wherein the response template comprises a preconfigured issue title and a preconfigured issue response; and causing display of the response template in an issue tracking user interface rendered on a user computing device in response to user input indicating a selection of the response template from one or more response templates, wherein displaying the response template comprises populating one or more template variables associated with the response template.

In some embodiments, generating the response template comprises generating a retrieval-augmented response based on the input issue data object, the one or more similar issue data objects, and the one or more relevant knowledge documents; and generating the response template based on the retrieval-augmented response and the one or more template variables.

In some embodiments, generating the response template comprises identifying the one or more template variables from a plurality of template variables; and modifying the retrieval-augmented response to include the one or more template variables.

In some embodiments, generating the response template comprises generating a retrieval-augmented prompt comprising the retrieval-augmented response and at least the one or more template variables; and inputting the retrieval-augmented prompt into the generative AI model.

In some embodiments, the computer-implemented method further comprises storing the response template in a storage location.

In some embodiments, causing display of the response template in the issue tracking user interface comprises receiving a template request indication via the issue tracking user interface; rendering a template selection interface comprising the one or more response templates; and retrieving the response template from the storage location in response to the user input indicating the response template.

In some embodiments, identifying the one or more similar issue data objects comprises generating an issue similarity score set based on the input issue data object and the one or more previous issue data objects by applying a similarity function to the input issue data object and the one or more previous issue data objects; and selecting the one or more similar issue data objects from the one or more previous issue data objects based on the issue similarity score set.

In some embodiments, identifying the one or more relevant knowledge documents comprises generating a knowledge similarity score set based on the input issue data object and the one or more knowledge documents by applying a similarity function to the input issue data object and the one or more knowledge documents; and selecting the one or more relevant knowledge documents from the one or more knowledge documents based on the knowledge similarity score set.

In accordance with another aspect of the present disclosure, an apparatus for retrieval-augmented template generation is provided. The apparatus in some embodiments comprises at least one processor and at least one memory including program code, the at least one memory and the program code configured to, with the at least one processor, cause the apparatus to at least identify one or more similar issue data objects from one or more previous issue data objects based on one or more issue features associated with an input issue data object; identify one or more relevant knowledge documents from one or more knowledge documents based on the one or more issue features; generate a response template using a generative AI model and based on the input issue data object, the one or more similar issue data objects, and the one or more relevant knowledge documents, wherein the response template comprises a preconfigured issue title and a preconfigured issue response; and cause display of the response template in an issue tracking user interface rendered on a user computing device in response to user input indicating a selection of the response template from one or more response templates, wherein displaying the response template comprises populating one or more template variables associated with the response template.

In some embodiments, generate the response template comprises generating a retrieval-augmented response based on the input issue data object, the one or more similar issue data objects, and the one or more relevant knowledge documents; and generating the response template based on the retrieval-augmented response and the one or more template variables.

In some embodiments, generate the response template comprises identifying the one or more template variables from a plurality of template variables; and modifying the retrieval-augmented response to include the one or more template variables.

In some embodiments, generate the response template comprises generating a retrieval-augmented prompt comprising at least (i) one or more prompt example and (ii) the one or more template variables; and inputting the retrieval-augmented prompt into the generative AI model.

In some embodiments, the apparatus is further caused to store the response template in a storage location for access by one or more client computing devices.

In some embodiments, cause display of the response template in the issue tracking user interface comprises receiving a template request indication via the issue tracking user interface; rendering a template selection interface comprising the one or more response templates; and retrieving the response template from the storage location in response to the user input indicating the response template.

In some embodiments, identify the one or more similar issue data objects comprises generating an issue similarity score set based on the input issue data object and the one or more previous issue data objects by applying a similarity function to the input issue data object and the one or more previous issue data objects; and selecting the one or more similar issue data objects from the one or more previous issue data objects based on the issue similarity score set.

In some embodiments, identify the one or more relevant knowledge documents comprises generating a knowledge similarity score set based on the input issue data object and the one or more knowledge documents by applying a similarity function to the input issue data object and the one or more knowledge documents; and selecting the one or more relevant knowledge documents from the one or more knowledge documents based on the knowledge similarity score set.

In accordance with another aspect of the present disclosure, at least one non-transitory computer-readable storage medium for retrieval-augmented template generation is provided. The at least one non-transitory computer-readable storage medium in some embodiments comprises at least one non-transitory computer-readable storage medium having computer coded instructions configured to, when executed by at least one processor identify one or more target responses associated with a plurality of previous issue responses based one or more duplication events associated with the plurality of previous issue responses; generate one or more target response groups based on the one or more target responses by applying a similarity function to the one or more target responses; and generate a response template using a generative AI model and based on a representative response associated with a target response group of the one or more target response groups, wherein the response template comprises a preconfigured issue title and a preconfigured issue response; and store the response template in a storage location for access by one or more client computing devices.

In some embodiments, identify the one or more target responses comprises determining a duplication event count associated with each previous issue response of the plurality of previous issue responses; and comparing each previous duplication event count to a duplication threshold, wherein each target response of the one or more target responses satisfies the duplication threshold.

In some embodiments, generate the response template comprises modifying the representative response to include one or more template variables.

In some embodiments, generate the response template comprises generating a retrieval-augmented prompt comprising at least (i) one or more prompt example and (ii) one or more template variables; and inputting the retrieval-augmented prompt into the generative AI model.

### BRIEF DESCRIPTION OF THE SEVERAL VIEW OF THE DRAWINGS

Having thus described some embodiments in general terms, references will now be made to the accompanying drawings, which are not drawn to scale, and wherein:

FIG. 1 is a block diagram of an example issue tracking system architecture within which at least some embodiments of the present disclosure may operate.

FIG. 2 is a block diagram of an issue tracking apparatus structured in accordance with at least some embodiments of the present disclosure.

FIG. 3 is a block diagram of an example client computing device structured in accordance with at least some embodiments of the present disclosure.

FIG. 4A illustrates a visualization of an example data environment for generating response templates in accordance with at least some embodiments of the present disclosure.

FIG. 4B illustrates a visualization of an example data environment for generating response templates in accordance with at least some embodiments of the present disclosure.

FIG. 5A illustrates an example retrieval-augmented prompt in accordance with at least some embodiments of the present disclosure.

FIG. 5B illustrates an example response template in accordance with at least some embodiments of the present disclosure.

FIGS. 6A-E each depict at least a partial view of example issue tracking user interface configured in accordance with at least some embodiments of the present disclosure.

FIG. 7 is a flowchart diagram of an example process for generating response templates in accordance with at least some embodiments of the present disclosure.

FIG. 8 is a flowchart diagram of an example process for generating response templates in accordance with at least some embodiments of the present disclosure.

### DETAILED DESCRIPTION OF SOME EMBODIMENTS

Various embodiments of the present disclosure now will be described more fully hereinafter with reference to the accompanying drawings, in which some, but not all embodiments of the disclosure are shown. Indeed, this disclosure may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment).

### Overview

Issue tracking tools are useful for agile project management teams, software developers, and other enterprise users for managing tasks and resolving alerts, errors, incidents, or problems during development, delivery, execution, debugging, incident identification, troubleshooting, and/or operation of a software. In particular, issue ticket/issue management in issue tracking systems have become an integral part of customer support and service operations across various industries. In this regard, issue tracking systems allow organizations to efficiently track, prioritize, and resolve customer issues and requests. For instance, an issue tracking system may be designed at least in part for managing service requests, incidents, problems, alerts, information request, access request, and/or other issues from end-users of a software application. The issue tracking system may be designed to allow for end-users to create and submit issue tickets/issues—that include such service requests, incidents, problems, information request, access request, and/or other issues—to an organization or team member (e.g., support agent) tasked with or otherwise responsible for resolving and/or responding to the issue ticket/issue. Further, the issue tracking system may be designed to allow for such organization or individual to document, track, resolve, and respond to the issue tickets/issues.

However, the process(es) of generating, editing, formatting, and/or responding to issues tracked in conventional issue tracking systems are unnecessarily time and resource consuming and often result in high latency and computing expenses. Particularly, as the volume of issue tickets/issues continue to grow, organizations and support teams face increasing pressure to provide timely and accurate responses while maintaining consistency and quality.

Traditionally, team members and organizations have relied on manually crafting responses for each issue ticket in conventional issue tracking systems by referencing knowledge sources (e.g., knowledge documents) and/or previous issue tickets/issues, which often involves searching for the relevant knowledge sources or relevant previous issue tickets/issues. This approach can be time-consuming, prone to inefficient resource consumption, and prone to inconsistencies in responses, to name a few, especially when dealing with common or recurring issues.

To address these challenges, some conventional issue tracking systems allow for a team member or organization to generate response templates (e.g., canned responses) that may be quickly accessed by the team member or organization. However, the effective use of such responses template generation capabilities of conventional issue tracking systems present its own challenges. For example, such conventional issue tracking systems rely on users to generate or otherwise initiate generation of response templates. Moreover, such conventional issue tracking systems rely on the user's familiarity with complex issue generation features of the conventional issue tracking systems as well the user's judgments with respect to when generation of a response template is appropriate. As the complexity and diversity of end-users (e.g., customers) inquiries grow, there is an increasing need for an improved issue tracking system that provides for generating and providing appropriate responses with low-latency and efficient resource consumption.

Various embodiments discussed herein provide a system, method, apparatus, and/or computer program product for response template generation that integrates similarity-based retrieval with generative artificial intelligence (AI) techniques (e.g., retrieval-augmented template generation framework as described herein) to dynamically and automatically initiate response template generation process, generate retrieval augmented generation (RAG) based response templates ((RAG)-based response templates), and recommend or otherwise provide contextually relevant and consistent responses based on the RAG-based response templates. In particular, various embodiments, using a retrieval-augmented template generation framework, generates RAG-based response templates based on the specific context of an input issue data object (e.g., current or new issue) and relevant historical data such as similar issue data objects and/or knowledge documents (e.g., enterprise-specific knowledge).

In some embodiments, an issue tracking system described herein is configured to receive an input issue data object and extract one or more issue features from the input issue data object. In some embodiments, the issue tracking system is configured to, using one or more retrieval models and based on the one or more extracted issue features, identify and retrieve similar issue data object(s) with respect to the input issue data object. In some embodiments, the identified similar issue data object(s) comprise a selected subset of a plurality of similar previous issue data.

In some embodiments, the issue tracking system is configured to, using one or more retrieval models and based on the one or more extracted issue features, identify and retrieve relevant knowledge document(s). In some embodiments, the identified knowledge document(s) comprise a selected subset of a plurality of relevant knowledge documents.

In some embodiments, the issue tracking system is configured to generate RAG-based response templates by analyzing and synthesizing the input issue data object, the similar issue data objects, and/or the relevant knowledge documents using a generative AI model and retrieval-augmented prompt. In some embodiments, the issue tracking system is configured to dynamically provide response templates to users.

By using a retrieval-augmented template generation framework that integrates similarity-based retrieval techniques with generative AI and leverages enterprise-specific knowledge to guide the generative AI model to dynamically and automatically generate contextually relevant and consistent response templates, various embodiments of the present disclosure provide improvements to various technical fields and technologies, including technical improvements to (i) machine learning and artificial intelligence template generation techniques and (ii) issue tracking systems. Further, by dynamically initiating and generating RAG-based response templates, various embodiments of the present disclosure (i) improve user efficiency, (ii) reduce resource consumption, (iii) improves issue resolution efficiency, (iv) provide consistency across responses and users, (v) facilitates knowledge transfer, and (vi) improves latency.

### Definitions

As used herein, the terms “data,” “content,” “digital content,” “information,” and similar terms may be used interchangeably to refer to data capable of being transmitted, received, and/or stored in accordance with embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The term “computer-readable storage medium” refers to a non-transitory, physical or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The terms “client computing device,” “computing device,” “client computing entity” “network device,” “computer,” “user equipment,” and similar terms may be used interchangeably to refer to a computer comprising at least one processor and at least one memory. In some embodiments, the client computing device may further comprise one or more of: a display device for rendering one or more of a graphical user interface (GUI), a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client computing device” may refer to computer hardware and/or software that is configured to access a service made available by a server. The server is often, but not always, on another computer system, in which case the client accesses the service by way of a network. Embodiments of client computing devices may include, without limitation, smartphones, tablet computers, laptop computers, personal computers, desktop computers, enterprise computers, and the like. Further non-limiting examples include wearable wireless devices such as those integrated within watches or smartwatches, eyewear, helmets, hats, clothing, earpieces with wireless connectivity, jewelry and so on, universal serial bus (USB) sticks with wireless capabilities, modem data cards, machine type devices or any combinations of these or the like.

The term “circuitry” may refer to hardware-only circuit implementations (e.g., implementations in analog circuitry and/or digital circuitry); combinations of circuits and one or more computer program products that comprise software and/or firmware instructions stored on one or more computer readable memory devices that work together to cause an apparatus to perform one or more functions described herein; or integrated circuits, for example, a processor, a plurality of processors, a portion of a single processor, a multicore processor, that requires software or firmware for operation even if the software or firmware is not physically present. This definition of “circuitry” applies to all uses of this term herein, including in any claims. Additionally, the term “circuitry” may refer to purpose-built circuits fixed to one or more circuit boards, for example, a baseband integrated circuit, a cellular network device or other connectivity device (e.g., Wi-Fi card, Bluetooth circuit, etc.), a sound card, a video card, a motherboard, and/or other computing device.

The terms “application,” “software application,” “app,” “product,” “service” or similar terms refer to a computer program or group of computer programs designed to perform coordinated functions, tasks, or activities for the benefit of a user or group of users. A software application can run on a server or group of servers (e.g., a physical or virtual servers in a cloud-based computing environment). In certain embodiments, an application is designed for use by and interaction with one or more local, networked or remote computing devices, such as, but not limited to, client computing devices. Non-limiting examples of an application comprise issue tracking software applications, project management, workflow engines, service desk incident management, team collaboration suites, cloud services, word processors, spreadsheets, accounting applications, web browsers, email clients, media players, file viewers, videogames, audio-video conferencing, and photo/video editors. In some embodiments, an application is a cloud product.

The term “data object” refers to a data structure, associated with one or more data elements or values in a computer-readable storage medium and/or computer-readable transmission medium, that represents content that is configured for use or display by one or more software applications, services, and/or microservices. A data object may take the structural form of a vector or other appropriate data structure for representing data. A data object may include metadata and may be stored via computer-readable storage medium (e.g., with a repository associated with a server). A data object (or one or mor values thereof) may be transmittable between services, microservices, applications, modules, computing devices, and/or systems by way of a computer-readable transmission medium (e.g., telecommunication signals, wired/wireless electrical signals, and/or the like). In some embodiments, a data object may comprise a plurality of data objects. A data object may be configured to follow a predefined format.

The term “application programming interface” or “API” refer to a computing interface that defines indication inputs between applications, services, microservices, computing devices, repositories, and/or the like of an issue tracking system or a multi-layer service oriented platform. An application programming interface may define formatting for one or more of a programming code call, request, function, procedure, notification, data object, data structure, or the like. Non-limiting examples of an application programming interface may include JavaScript Object Notation (JSON), Extensible Markup Language (XML), Simple Object Access Protocol (SOAP), Hypertext Markup Language (HTML), the like, or combinations thereof.

The terms “issue” and “issue ticket” refer to a data entity that describes and/or includes a task to be completed. Non-limiting examples of such task includes service request tasks, incident resolution tasks, problem resolution tasks, software feature development tasks, and/or the like. For example, an issue may represent a helpdesk request for resolution, a project task, or the like. In some examples, an issue may be a technical task including, but not limited to, a process step, software development task, an alert, a conflict, error, or problem in at least one of the development, delivery, execution, debugging, incident identification, troubleshooting, and/or operation of a piece of software. An issue may capture various information about and/or related to a task and may be tracked and/or stored by an issue tracking system (also referred to as issue management system) in various forms. In some embodiments, an issue is represented, stored, and/or maintained in an issue tracking system in the form of an issue data object or otherwise associated with an issue data object.

The term “issue data object” refers to an electronically managed data structure storing information associated with an issue. In some embodiments, such information includes and/or is representative of one or more issue features that define an issue. In some embodiments, the one or more issue features include issue title, issue description, and/or comment. In some embodiments, an issue data object associated with an issue comprises one or more data fields for storing the issue features associated with the issue. In some embodiments, each issue feature may be stored in a unique data field of the one or more data fields. For example, the one or more data fields of an issue data object may comprise a title field for storing the issue title of the issue associated with the issue data object, a description field for storing the issue description of the issue associated with the issue data object, and a comment field for storing a response to the issue associated with the issue data object. The issue features may be stored in the respective issue fields as natural language text, vector representations (e.g., embeddings) of the issue features, or other representations of the issue features.

In some embodiments, an issue data object may comprise other data fields configured to store metadata and/or other data associated with an issue. Non-limiting examples of such other data fields include an identifier field for storing an issue identifier associated with an issue, a creation timestamp field for storing information (e.g., date, time, and/or like) indicating when an issue was created, an issue type field for storing information indicating the nature of the issue task (e.g., workspace request, hardware request, and/or the like), a status field for storing information indicating the status (e.g., closed, open, awaiting review, or the like) of an issue, an assignee field for storing information indicating the user (e.g., team member, support agent, and/or the like) assigned to complete an issue task, a related product field for storing data indicating related software applications, related tools, and/or the like, a priority field, issue creator field, issue permissions (e.g., whether individual users, user types, user groups or the like can read and/or edit the issue document), and/or change history field.

An issue data object may be stored and/or maintained in a storage location associated with or otherwise accessible to the issue tracking system. For example, an issue data object may be organized in a manner that makes it processable, storable, interpretable, and/or transmissible by an issue tracking system (or components thereof). In some embodiments, an issue data object may be generated by an issue tracking system in response to receiving an issue or otherwise user input representative of an issue. The issue tracking system may be configured to extract and/or generate relevant information from the issue and generate an issue data object comprising the information. The issue tracking system may be configured to store the information in the appropriate fields of the issue data object. In some embodiments, the issue tracking system is associated with a multi-layer service-oriented platform.

The term “input issue data object” refers to an issue data object that is leveraged by an issue tracking system to generate contextually relevant template responses. In some embodiments, an input issue data object is an issue data object that is associated with a current and/or new issue ticket. For example, an input issue data object may correspond to an issue ticket with respect to which a response is currently being submitted by a user.

The term “issue feature” refers to a data entity representative of a particular information associated with an issue. An issue feature may correspond to one or more fields of an issue ticket. For example, an issue feature may be representative or otherwise comprise the content of a particular field in an issue ticket. In some embodiments, examples of an issue feature include issue title (title), issue description (description), and comment. An issue title comprises a concise summary of an issue and may correspond to the content of a heading field (e.g., title field, name field, or the like) of an issue ticket. By way of example, an issue title may comprise concise summary such as login error, account access, or the like. An issue description comprises detailed information about the issue and may correspond to the content of a description field of an issue ticket. In particular, an issue description may comprise detailed information about one or more tasks (e.g., service request task, incident resolution task, information request task, access request task, or the like) to be completed. By way of example, an issue description may comprise detailed information such as error messages, software versions, or the like. A comment associated with an issue comprises information representative of a response to the issue and may correspond to the content of a comment field of an issue ticket. For example, a comment may represent or otherwise comprise a response to an issue task (e.g., service request task, incident resolution task, information request task, access request task, or the like).

The term “retrieval-augmented template generation framework” refers to response template generation framework, process, pipeline, operation, and/or the like that leverages retrieval-augmented generation (RAG) techniques to generate response templates. An issue tracking system described herein may integrate such RAG techniques to generate response templates (e.g., RAG-based response templates). In particular, an issue tracking system described herein may integrate and leverage a retrieval-augmented template generation framework to generate response templates. The retrieval-augmented template generation framework may include one or more information retrieval models (retrieval models) and one or more generative AI models. The retrieval-augmented template generation framework, for example, may integrate similarity-based retrieval with generative AI.

In some embodiments, the retrieval-augmented template generation framework is designed to retrieve relevant information from and/or including an input issue data object, one or more similar issue data object(s), and/or one or more relevant knowledge documents using similarity-based retrieval techniques (e.g., one or more similarity-based retrieval models). The retrieval-augmented template generation framework may be designed to generate response templates (e.g., RAG-based response templates) by analyzing and synthesizing the retrieved information using a generative AI model thereof. In some embodiments, the retrieval-augmented template generation framework is designed to generate, using the generative AI model, a RAG-based response by analyzing and synthesizing the retrieved information and generate the response templates based on the RAG-based response. In some embodiments, generating the response template comprise modifying the RAG-based response to include relevant template variables. In some embodiments, the retrieval retrieval-augmented template generation framework is designed to generate a contextually relevant title (e.g., RAG-based title) for the response template using the retrieved information.

The term retrieval-augmented prompt refers to an input provided to a model such as a generative AI model and is configured to guide the model to generate a contextually relevant output. The retrieval-augmented prompt may be augmented or otherwise include relevant retrieved context data. In some embodiments, such retrieved context data include the one or more similar issue data objects and the one or more knowledge documents.

The term “issue template creation trigger” refers to a signal, data, a message (e.g., an inter-service message, intra-service message, network message, etc.), and/or computer readable instructions that invokes or otherwise initiates generation of response template(s) by a computing device, such as a computing device associated with an issue tracking system describe herein. In some embodiments, the issue template creation trigger is a response creation indication. In some embodiments, the issue template creation trigger is a template generation request.

The term “response creation indication” refers to signal, data, a message (e.g., an inter-service message, intra-service message, network message, etc.), and/or computer readable instructions descriptive of an indication of a response creation event associated with an input issue data object. A response creation event may occur when a response is generated in an issue tracking system based on user input. For example, a user may provide a response (e.g., text data, image data, and/or other forms of information) to an issue associated with an input issue data object. For example, the response may be a response to a service request, an information request, an access request and/or the like. The response may be provided by a user via an issue tracking user interface associated with the issue tracking system. In some embodiments, a client application associated with the issue tracking system and executing on a client computing device may be configured to transmit response creation indications to a computing device associated with the issue tracking system.

The term “template generation request” refers to a signal, data, message (e.g., an inter-service message, intra-service message, network message, etc.), and/or computer readable instructions descriptive of a request from a client computing device to an issue tracking system to generate a response template.

The term “similar issue data object” refers to a previous issue data object that is similar to an input issue data object. A previous issue data object may be identified as a similar issue data object with respect to an input issue data object based on a similarity score (and/or other similarity metric) associated with the issue data object. For example, a similar issue data object may comprise a previous issue data object having a similarity score that satisfies (e.g., exceeds, is equal to, less than, or the like) an issue similarity threshold. In this regard, the previous issue associated with the similar issue data object is determined to be similar to the issue associated with the input issue data object.

The term “issue similarity score” refers to a value indicating how similar or otherwise a first issue data object is to a second issue data object. An issue similarity score may be calculated based on at least a subset of the issue feature(s) of the first issue data object (e.g., previous issue data object) and the corresponding subset of issue feature(s) of the second issue data object (e.g., input issue data object). For example, the closer the features of the first issue data object are to the corresponding features of the second issue data object, the more similar the first issue data object and the second data object are likely to be. By way of example, an issue similarity score may range from 0 to 1, where 1 indicates perfect similarity and 0 indicates no similarity (or vice versa).

Any of a variety of similarity functions may be leveraged by an issue tracking system to generate an issue similarity score. Non-limiting examples of such similarity functions include cosine similarity, Levenshtein distance, Manhattan distance, Euclidean distance, semantic similarity, lemmatized string similarity, term frequency comparison, Jaccard similarity, and/or the like. In some embodiments, the similarity function(s) leveraged to generate the issue similarity scores may be selected based on the data type and/or tailored to the specific characteristics of the data type. In some embodiments, the selected similarity function is cosine similarity function. In some embodiments such as where cosine similarity function is leveraged to generate issue similarity scores, vector representations of the feature(s) of the respective issue data objects may be generated and leveraged to generate the issue similarity score. For example, a cosine similarity function may measure the cosine of the angle between two vectors in a multi-dimensional space, where each dimension represents an issue feature. One or more techniques such as, but not limited to, term frequency-inverse document frequency (TF-IDF) or word embeddings may be leveraged to generate the vector representations which may comprise converting the textual issue features into numerical vectors. In some embodiments, the issue tracking system may use a combination of similarity functions or advanced techniques such as semantic similarity measures based on word embeddings or sentence encoders. Such techniques may capture more nuanced relationships between issue data objects.

The term “knowledge similarity score” refers to a value indicating how relevant or otherwise a knowledge document is to an issue data object. A knowledge similarity score may be calculated based on at least a subset of the issue feature(s) of the issue data object (e.g., input issue data object). For example, the closer the features of the issue data object is to the content (e.g., text) of the knowledge document, the more relevant the knowledge document is to the issue data object. By way of example, a knowledge similarity score may range from 0 to 1, where 1 indicates high relevance similarity and 0 indicates low relevance (or vice versa). A knowledge similarity score may be calculated using any of various of similarity functions. Non-liming examples of such similarity functions include cosine similarity, Levenshtein distance, Manhattan distance, Euclidean distance, semantic similarity, lemmatized string similarity, term frequency comparison; Jaccard similarity, and/or the like.

In some embodiments, the similarity function(s) leveraged to generate the knowledge similarity scores may be selected based on the data type and/or tailored to the specific characteristics of the data type. In some embodiments, the selected knowledge similarity function is a Jaccard similarity function. A Jaccard similarity function may be particularly useful for comparing sets of keywords or topics associated with knowledge documents. In some embodiments, vector representations of the feature(s) of the issue data object and vector representations of one or more text segments of the knowledge document may be generated and leveraged to generate the knowledge similarity score. In some embodiments, the issue tracking system may use a combination of similarity functions or advanced techniques such as semantic similarity measures based on word embeddings or sentence encoders. Such techniques may capture more nuanced relationships between the input issue data object and knowledge documents beyond keyword matching.

The term “response template” refers to an electronically managed data structure representative of a preconfigured response (e.g., pre-written response, canned response, or similar terms). A response template may comprise a preconfigured response that defines or otherwise includes one or more template variables. A response template may be associated with a particular issue type or a group of issue types. For instance, a particular response template may be configured for being leveraged to respond to issues of a particular issue type. An issue type as described herein may be defined by one or more issue features (e.g., issue description, issue title, and/or the like). A response template may be generated using a retrieval-augmented template generation framework and based on an input issue data object, one or more similar issue data objects, and/or one or more relevant knowledge documents. In this regard, a response template may comprise a contextually relevant RAG-based response template output by a retrieval-augmented template generation framework integrated with an issue tracking system. In some embodiments, the issue tracking system generates retrieval-augmented prompts that guide a generative AI model of the retrieval-augmented template generation framework in generating the response templates.

In some embodiments, a response template may be generated based on frequently duplicated responses (e.g., frequently copy-pasted responses). For example, an issue tracking system described herein may be configured to identify and analyze previous responses that are frequently copy-pasted by users of the issue tracking system and generate response templates based on the analysis. In some embodiments, the analysis may include determining duplication event count associated with the identified responses and comparing the duplication event count to a duplication threshold. In some embodiments, the analysis may include identifying common patterns used by team members (e.g., user) for specific types of issues. For example, if a user frequently copy and paste a specific set of troubleshooting steps for a common login issue, the feature extraction module may identify this pattern and generate a response template comprising these steps including template variables (e.g., placeholders) for user-specific information and/or issue-specific information.

A response template may be provided to a client computing device in response to a template selection indication corresponding to the response template. For instance, a user may be prompted to select from one or more response templates and provided a response template from the one or more response templates that corresponds to the user's selection. The selected response template, for example, may be provided for display to a user via an issue tracking user interface associated with an issue tracking system as described herein.

The term “template variable” refers to a placeholder for user-specific and/or issue-specific information in a response template. For example, a template variable within a response template may be configured for being modified by the user to, for example, ensure flexibility and reusability of response templates across different users, projects, or support scenarios. The placeholders may be clearly marked within the response template, prompting a user (e.g., agents, team members, and/or the like) to input relevant details. For example, a placeholder might indicate where a user should insert a customer's name, specific issue details, and/or the like. Non-limiting examples of template variables include current user, issue assignee, issue key, issue reporter, issue resolution, issue summary, portal URL, request status, or request URL. Alternatively, or additionally, in some embodiments, the issue tracking system may be configured to automatically populate the templated variables based on, for example, information associated with the user prior to providing the response template to the user.

The term “response template request” refers to signal, data, message (e.g., an inter-service message, intra-service message, network message, etc.), and/or computer readable instructions descriptive of a request from a client computing device to an issue tracking system to provide a selected response template,

The term “issue tracking user interface” refers to a user interface configured to render information to a user. In particular, the issue tracking user interface may be configured to render response templates and/or information related to generating response templates to a user. Additionally, the issue tracking user interface may be configured to receive user input. An issue tracking user interface may be generated by or otherwise provided by an issue tracking system to be displayed on the visual display of a user computing device. In some embodiments, the issue tracking user interface comprises one or more interactive interface elements and/or components associated with an issue tracking system such that interaction with the one or more interactive interface elements and/or components may cause the issue tracking system to receive and/or execute various commands. In some embodiments, an issue tracking system described herein or client application associated with the issue tracking system may be configured to cause an issue data object associated with an issue to be generated, initialized, updated, and/or the like based on user interaction with the issue tracking user interface.

The term “template selection indication” refers to a signal, data, message (e.g., an inter-service message, intra-service message, network message, etc.), and/or computer readable instructions descriptive of an indication received by a computing device (such as computing device associated with an issue tracking system) indicating a selected response template.

The term “issue identifier” refers to one or more items or elements by which an issue data object may be uniquely identified from other issue data objects. The issue identifier may be in the form of text string(s), numerical character(s), alphabetical character(s), alphanumeric code(s), American Standard Code for information Interchange (ASCII) characters(s), and/or the like.

The term “multi-layer service-oriented platform” refers to a complex network computing environment associated with a multitude of computing devices, applications, services, and microservices. For example, in some embodiments, a multi-layer service-oriented platform includes dozens of applications that are supported by 1000+ services operating within a cloud-based platform. Example multi-layer service-oriented platforms may comprise a federated network of computing devices, and/or a plurality of database platforms (e.g., servers, hard-drives, etc.). Applications and services or microservices of example multi-layer service-oriented platforms may be hosted by internal resources or external resources. Multi-layer service-oriented platforms may support multiple applications that are configured for the collection of information (e.g., in the form of application data objects), storing of information collected, managing of information collected, processing of information collected and/or providing other services, individually or collectively, for the benefit of a user. Each software application may include a number of features, with many features (e.g., user authentication features) shared between multiple software applications. Other features may be supported only by one associated software application or a defined subset of software applications. A given multi-layer service-oriented platform could support hundreds of software applications and hundreds of thousands of features. Those applications and features could be supported by thousands of services and microservices that exist in vast and ever-changing interdependent layers.

Software development teams may release code updates that change various software services, launch new software services, change existing features of existing software applications, add new software applications, add new software application features to existing software applications, and/or the like. Non-limiting example of applications and/or tools that may be included in a multi-layer service-oriented platform, include Jira Software® by Atlassian, Inc. Jira Service Management® by Atlassian Inc., Confluence® by Atlassian, Inc., JIRA Service Desk by Atlassian®., Inc., Loom® video messaging, and Trello®.

The term “internal resource” refers to a software program, application, platform, or service that is configured by an organization (e.g., an enterprise owner of a multi-layer service-oriented platform) to provide functionality to another one or more of the software programs, applications, platforms, or services operating on a multi-layer service-oriented platform, either directly or indirectly, through one or more other services. Internal resources operate on a compiled code base and/or use data repositories that are at least partially shared by other software programs, applications, or services of the multi-layer service-oriented platform. In some embodiments, application code bases, service code bases, and code bases that support an internal resource are hosted on common servers or using computing devices operating within a common intranet or network.

The term “external resource” refers to a software program, application, platform, or service that is configured to communicate with applications, services, software programs, and/or devices of a multi-layer service-oriented platform but which operates on a compiled code base that is separate from code bases of the multi-layer service-oriented platform. In some embodiments, communications between an external resource and an application or service calling the external resource takes place through a firewall and/or other network security features of the multi-layer service-oriented platform. The external resource operates on a compiled code base or repository that is separate and distinct from that which supports the application or service of the multi-layer service-oriented platform calling the external resource. The external resource is generally considered outside of the ecosystem of internal resources that are generated, operated, maintained, and controlled by developers of the multi-layer service oriented platform.

The terms “input,” “indication,” “indication input,” “interaction,” “interaction input,” or the like refer to an identifiable, non-transitory occurrence that has technical significance for system hardware and/or software. In some embodiments, an interaction input may be user-generated via at least a user interface associated with a computing device, such as keystrokes, mouse movements, voice commands, and/or the like. In some embodiments, an interaction input may be application-generated (i.e., automatically and/or dynamically internally generated by an application via at least computing circuitry), such as program loading, compiling a data object, errors, and/or the like. For example, an application function may be caused by, and/or a data object may be generated in response to, a user interface interaction input and/or an internal confirmation interaction input generated by the application or associated computing device(s).

The terms “machine learning module,” “machine learning model,” “ML module(s),” “ML model(s),” artificial intelligence,” or “AI” refer to a machine learning or deep learning task or mechanism. The term “machine learning” refers to a method used to devise complex models and algorithms that lend themselves to prediction. A machine learning model is a computer-implemented algorithm that may learn from data with or without relying on rules-based programming. These models enable reliable, repeatable decisions and results and uncovering of hidden insights through machine-based learning from historical relationships and trends in the data. In some embodiments, the machine learning model is a clustering model, a regression model, a neural network, a random forest, a decision tree model, a classification model, a large language model as defined above, or the like.

A machine learning model may be initially fit or trained on a training dataset (e.g., a set of examples used to fit the parameters of the model). The model may be trained on the training dataset using supervised or unsupervised learning. The model may be run with the training dataset and produce a result, which is then compared with a target, for each input vector in the training dataset. Based on the result of the comparison and the specific learning algorithm being used, the parameters of the model may be adjusted.

The machine learning models as described herein may make use of multiple ML engines (e.g., for analysis, transformation, and other needs). The system may train different artificial intelligence and/or machine learning (AI/ML) models for different needs and different ML-based engines. The system may generate new models (based on the gathered training data) and may evaluate their performance against the existing models. Training data may include any of the gathered information, as well as information on actions performed based on the various recommendations.

The AI/ML models may be any suitable model for the task or activity implemented by each ML-based engine. Machine learning models may be some form of neural network. The underlying AI/ML models may be learning models (supervised or unsupervised). As examples, such algorithms may be prediction (e.g., linear regression) algorithms, classification (e.g., decision trees) algorithms, time-series forecasting (e.g., regression-based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g., FCN, PSPNet, U-Net) sequence to sequence models (e.g., RNNs, LSTMs, BERT, Autoencoders) or Generative AI models (e.g., GANs).

The AI/ML models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative AI models (such as Generative Adversarial Networks or auto-encoders, generative pre-trained transformer (GPT) model, or the like).

In various embodiments, the AI/ML models may undergo a training or learning phase before they are released into a production or runtime phase or may begin operation with models from existing systems or models. During a training or learning phase, the AI/ML models may be tuned to focus on specific variables, to reduce error margins, or to otherwise optimize their performance. The AI/ML models may initially receive input from a wide variety of data, such as the gathered data described herein. The ML models herein may undergo a second or multiple subsequent training phases for retraining the models.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The terms “illustrative,” “example,” “exemplary” and the like are used herein to mean “serving as an example, instance, or illustration” with no indication of quality level. Any implementation described herein as “exemplary” is not necessarily to be construed as preferred or advantageous over other implementations.

The phrases “in one embodiment,” “according to one embodiment,” and the like generally mean that the particular feature, structure, or characteristic following the phrase may be included in the at least one embodiment of the present invention and may be included in more than one embodiment of the present invention (importantly, such phrases do not necessarily refer to the same embodiment).

The terms “about,” “approximately,” or the like, when used with a number, may mean that specific number, or alternatively, a range in proximity to the specific number, as understood by persons of skill in the art field.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

The term “plurality” refers to two or more items.

The term “set” refers to a collection of one or more items.

The term “or” is used herein in both the alternative and conjunctive sense, unless otherwise indicated.

Thus, use of any such terms, as defined herein, should not be taken to limit the spirit and scope of embodiments of the present disclosure.

### Example System Architecture

Embodiments of the present disclosure may be implemented in various ways, including as computer program products that comprise articles of manufacture, as hardware, including circuitry, configured to perform one or more functions, and/or as combinations of specific hardware and computer program products. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may be implemented as one or more methods, apparatuses, systems, computing devices (e.g., user devices, servers, etc.), computing entities, and/or the like. As such, embodiments of the present disclosure may take the form of an apparatus, system, computing device, computing entity, and/or the like executing instructions stored on one or more computer-readable storage mediums (e.g., via the aforementioned software components and computer program products) to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams, flowchart illustrations, and other example visualizations. It should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. In embodiments in which specific hardware is described, it is understood that such specific hardware is one example embodiment and may work in conjunction with one or more apparatuses or as a single apparatus or combination of a smaller number of apparatuses consistent with the foregoing according to the various examples described herein. Accordingly, the block diagrams and flowchart illustrations support various combinations of embodiments for performing the specified instructions, operations, or steps.

Methods, apparatuses, and computer program products of the present disclosure may be embodied by any of a variety of devices. For example, the method, apparatus, and computer program product of an example embodiment may be embodied by a networked device (e.g., a federated software platform, or the like), such as a server or other network entity, configured to communicate with one or more devices, such as one or more query-initiating computing devices. Additionally, or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, the like or any combination of the aforementioned devices.

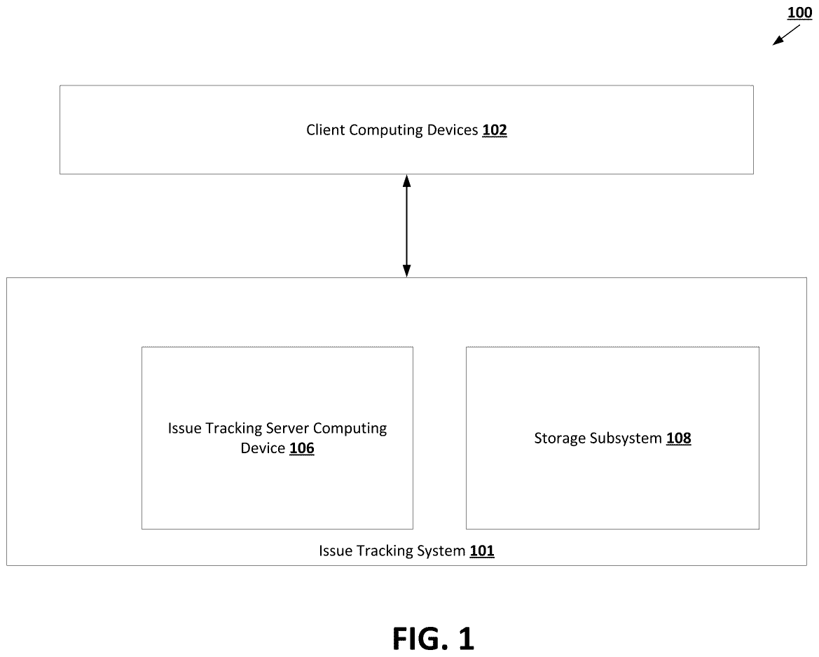

In this regard, FIG. 1 shows an example issue tracking system architecture 100 within which embodiments of the present disclosure may operate. The depiction of the example issue tracking system architecture 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1 and the issue tracking system architecture 100 disclosed therein is merely presented to provide an example basis and context for the facilitation of some of the features, aspects, and uses of the methods, apparatuses, computer readable media, and computer program products disclosed and contemplated herein. It will be understood that while many of the aspects and components presented in FIG. 1 are shown as discrete, separate elements, other configurations may be used in connection with the methods, apparatuses, computer readable media, and computer programs described herein, including configurations that combine, omit, and/or add aspects and/or components.

As shown in FIG. 1, the issue tracking system architecture 100 includes an issue tracking system 101. The issue tracking system 101 may be or comprise services, microservices, platform, and/or a software application that is configured for execution via one or more computing devices. The one or more computing devices and its associated components facilitate the execution, tracking, and management of issues in various contexts. For instance, the issue tracking system 101 may be implemented in a service desk scenario, in which issues may be user requests or tickets logged with the service desk. In this regard, the issue tracking system 101 may find particular application in managing a service desk of an organization's information technology function and allow the organization to design, plan, deliver, operate, and/or control the services that it offers to clients.

In some examples, the issue tracking system 101 may be implemented in a project management scenario, in which the issues may be project tasks or work items; implemented in a software development scenario, in which issues may be bugs, software features currently under development, and/or software features intended for future development, or implemented in an organization administration scenario, in which issues may be administrative processes or forms (e.g., leave requests processes/forms or the like). It would be appreciated that the issue tracking system 101 may be implemented in other scenarios. In some embodiments, the issue tracking system is a software application of a plurality of software application, tools, features, services, microservices, and/or the like associated with a multi-layer service-oriented platform, as described herein.

The issue tracking system 101 may include a frontend and a backend. The frontend may be configured to operate as an instance of software application (a “client application”) executing on a client computing device. The client application may be configured to provide users (e.g., team members, support agents, end-users, or the like) access to the issue tracking system 101 and its associated functionality. For example, a client computing device may be configured to leverage a processor and memory thereof to instantiate an instance of the client application, which in turn leverages a display of the client computing device to render an issue tracking user interface of the issue tracking system to the user. For example, a user of the issue tracking system 101 may consume and/or interact with information associated with issues tracked by the issue tracking system 101 via the issue tracking user interface. The client application, in some examples, may be configured to operate in a browser of the client computing device. In some examples, the client application may be a native application. The backend may be configured to operate as an instance of software application executing on one or more server computing devices, such as an issue tracking server computing device 106, described further below. Examples of an issue tracking system 101 include JIRA Service Management by Atlassian®., Inc., Jira by Atlassian®., Inc., and JIRA Service Desk by Atlassian®., Inc.

In some embodiments, an issue or issue ticket is a data entity that describes and/or includes a task to completed. Non-limiting examples of such task includes service request tasks, incident resolution tasks, problem resolution tasks, software feature development tasks, and/or the like. For example, an issue may represent a helpdesk request for resolution, a project task, or the like. In some examples, an issue may be a technical task including, but not limited to, a process step, software development task, an alert, a conflict, error, or problem in at least one of the development, delivery, execution, debugging, incident identification, troubleshooting, and/or operation of a piece of software. An issue may capture various information about and/or related to a task and may be tracked and/or stored by an issue tracking system in various forms. In some embodiments, an issue is represented, stored, and/or maintained in an issue tracking system in the form of an issue data object or otherwise associated with an issue data object.

In some embodiments, an issue data object is an electronically managed data structure storing information associated with an issue. In some embodiments, such information include and/or is representative of one or more issue features that define an issue. In some embodiments, the one or more issue features include issue title, issue description, and/or comment.

In some embodiments, an issue data object associated with an issue comprises one or more data fields for storing the issue features associated with the issue. In some embodiments, each issue feature may be stored in a unique data field of the one or more data fields. For example, the one or more data fields of an issue data object may comprise a title field for storing the issue title of the issue associated with the issue data object, a description field for storing the issue description of the issue associated with the issue data object, and a comment field for storing a response to the issue associated with the issue data object. The issue features may be stored in the respective issue fields as natural language text, vector representations (e.g., embeddings) of the issue features, or other representations of the issue features.

In some embodiments, an issue data object may comprise other data fields configured to store metadata and/or other data associated with an issue. Non-limiting examples of such other data fields include an identifier field for storing an issue identifier associated with an issue, a creation timestamp field for storing information (e.g., date, time, and/or like) indicating when an issue was created, an issue type field for storing information indicating the nature of the issue task (e.g., workspace request, hardware request, and/or the like), a status field for storing information indicating the status (e.g., closed, open, awaiting review, or the like) of an issue, an assignee field for storing information indicating the user (e.g., team member, support agent, and/or the like) assigned to complete an issue task, a related product field for storing data indicating related software applications, related tools, and/or the like, a priority field, issue creator field, issue permissions (e.g., whether individual users, user types, user groups or the like can read and/or edit the issue document), and/or change history field.

An issue data object may be stored and/or maintained in a storage location (e.g., storage subsystem 108 and/or the like) associated with or otherwise accessible to the issue tracking system 101. For example, an issue data object may be organized in a manner that makes it processable, storable, interpretable, and/or transmissible by an issue tracking system 101 (or components thereof). In some embodiments, an issue data object may be generated by an issue tracking system in response to receiving an issue (e.g., issue ticket) or otherwise user input representative of an issue. The issue tracking system 101 may be configured to extract and/or generate relevant information from the issue and generate an issue data object comprising the information. The issue tracking system 101 may be configured to store the information in the appropriate fields of the issue data object.

As shown in FIG. 1, the issue tracking system architecture 100 includes an issue tracking system 101 in communication with one or more client computing devices 102. The issue tracking system 101 may be configured to provide various functionalities as described above. Additionally, the issue tracking system 101 is configured to provide dynamic and automated response template generation functionality. Specifically, the issue tracking system 101 is configured to dynamically and automatically initiate and generate response templates, store the response templates, and provide the response templates to client computing devices 102 in response to the response template requests.

The issue tracking system 101 integrates similarity-based retrieval with generative artificial intelligence (AI) techniques (e.g., retrieval-augmented template generation techniques) to dynamically and automatically initiate a response template generation process configured to generate response templates. Additionally, the issue tracking system 101 leverages the retrieval-augmented template generation techniques described herein to dynamically and automatically suggest or otherwise recommend response templates.

In particular, the issue tracking system 101, using a retrieval-augmented template generation framework, dynamically and automatically generates response templates based on the specific context of an input issue data object (e.g., associated with a current issue) and relevant historical data such as relevant previous issue data objects (e.g., associated with previous issues tracked by the issue tracking system 101) and/or knowledge documents (e.g., enterprise domain-specific knowledge documents). In some embodiments, a knowledge document comprises information that may be used to determine the appropriate response to an issue/issue ticket. For example, a user, such as an agent, may consult relevant knowledge document(s) to determine the appropriate response to an issue/issue ticket.

In some embodiments, the functions of one or more of the illustrated components in FIG. 1 may be performed by a single computing device or by multiple computing devices, which devices may be local or cloud based. It will be appreciated that the various functions performed by the issue tracking system 101 (or portion thereof) and the one or more client computing devices 102 and/or the various functions performed by the components of the issue tracking system 101 may be embodied by a single apparatus, subsystem, or system comprising one or more sets of computing hardware (e.g., processor(s) and memory) configured to perform the various functions thereof. In some embodiments, one or more components of the issue tracking system 101 may be embodied by a client computing device 102.

Two or more of the components illustrated in the issue tracking system architecture 100 of FIG. 1 may be configured to communicate via one or more communication mechanisms, including wired or wireless connections, such as over a network, bus, or similar connection. For example, a network may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, the network may include a cellular telephone, an 802.11, 802.16, 802.20, and/or WiMAX network. Further, a network may include a public network, such as the Internet, a private network, such as an intranet, or combinations thereof, and may utilize a variety of networking protocols now available or later developed including, but not limited to TCP/IP based networking protocols.

The issue tracking system 101 includes an issue tracking server computing device 106. The issue tracking server computing device 106 is configured to perform various functionalities associated with the issue tracking system 101, including dynamically and automatically generating response templates. In some embodiment, the issue tracking server computing device 106 is configured to generate the response templates using a retrieval-augmented template generation framework comprising one or more AI/ML models.

In some embodiments, the issue tracking server computing device 106 is configured to receive an input issue data object associated with a current issue and extract one or more issue features from the input issue data object. In some embodiments, the issue tracking server computing device 106 is configured to, using one or more retrieval models of the retrieval-augmented template generation framework and based on the one or more extracted issue features, identify similar issue data object(s) with respect to the input issue data object. In some embodiments, the issue tracking server computing device 106 is configured to, using one or more retrieval models of the retrieval-augmented template generation framework and based on the one or more extracted issue features, identify relevant knowledge document(s).

In some embodiments, the issue tracking server computing device 106 is configured to generate a response template using a generative AI model of the retrieval-augmented template generation framework and based on the input issue data object, identified similar issue data object(s), and/or identified relevant knowledge documents. In some embodiments, the issue tracking server computing device 106 is configured to generate retrieval-augmented prompts that guide the generative AI model in generating the response templates. In some embodiments, the generative AI model comprises a large language model (LLM).

Alternatively, or additionally, in some embodiments, the issue tracking server computing device 106 is configured to generate a response template based on frequently duplicated responses (e.g., frequently copy-pasted responses). For example, the issue tracking server computing device 106 may be configured to identify and analyze previous responses that are frequently copy-pasted by users of the issue tracking system and generate response templates based on the analysis.

In some embodiments, the issue tracking server computing device 106 is configured to provide a response template to a client computing device 102 in response to a template selection indication corresponding to the response template. For instance, the issue tracking server computing device 106 may be configured to prompt a user to select from one or more response templates and provide, to a client computing device 102 associated with the user, a response template from the one or more response templates that corresponds to the user's selection. In some embodiments, the issue tracking server computing device 106 is configured to provide the selected response template for display to a user via an issue tracking user interface associated with an issue tracking system 101.

In some embodiments, the issue tracking system 101 and/or system architecture 100 includes a storage subsystem 108. The storage subsystem 108 may be configured to store input data, training data, and/or the like that may be used by the issue tracking system to perform various functionalities associated therewith. The storage subsystem 108 may be configured to store (e.g., persistently store and/or the like) response templates. In some embodiments, the storage subsystem 108 is configured to store one or more components of the retrieval-augmented template generation framework.

The storage subsystem 108 may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. Additionally, the storage subsystem 108 may be configured to store one or more artificial intelligence/machine learning models.

Two or more of the components illustrated in the architecture 100 illustrated in FIG. 1 may be configured to communicate via one or more communication mechanisms, including wired or wireless connections, such as over a network, bus, or similar connection. For example, the issue tracking server computing device 106 and the client computing devices 102 may communicate over one or more networks. A network may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, the network may include a cellular telephone, an 802.11, 802.16, 802.20, and/or WiMAX network. Further, a network may include a public network, such as the Internet, a private network, such as an intranet, or combinations thereof, and may utilize a variety of networking protocols now available or later developed including, but not limited to TCP/IP based networking protocols. In some embodiments, the protocol is a custom protocol of JavaScript Object Notation (JSON) objects sent via a WebSocket channel. In some embodiments, the protocol is JSON over RPC, JSON over REST/HTTP, and/or the like.

In some embodiments, the components depicted in FIG. 1, although not required to be an integral system, may be connected via one or more networks. In some embodiments, one or more APIs may be leveraged to communicate with and/or facilitate communication between one or more of the components illustrated in the issue tracking system architecture 100.

### Example Issue Tracking Server Computing Device

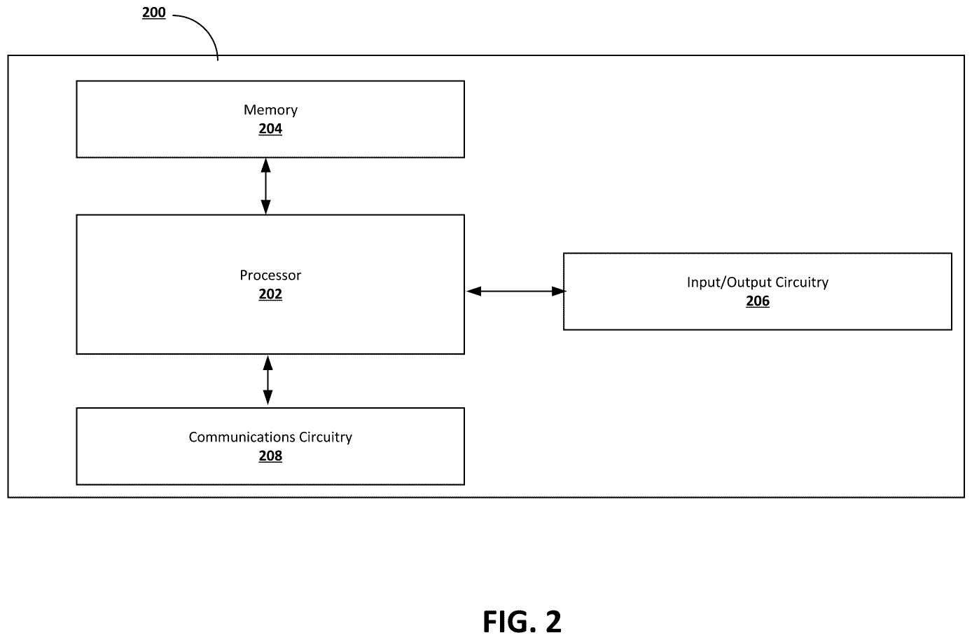

The example issue tracking server computing device 106 may be embodied by one or more computing systems, such as apparatus 200 (issue tracking apparatus 200) shown in FIG. 2. It should be noted, however, that the components, or elements illustrated in and described with respect to FIG. 2 may not be mandatory and thus one or more may be omitted in certain embodiments. Additionally, some embodiments, may include further or different components or elements beyond those illustrated in and described with respect to FIG. 2. In some embodiments, the apparatus 200 may comprise one or a plurality of physical devices.

The apparatus 200 may include processor 202, memory 204, input/output circuitry 206, communications circuitry 208. The apparatus 200 may be configured to execute the operations described herein. Although these components 202-208 are described with respect to functional limitations, it should be understood that the particular implementations necessarily include the use of particular hardware. It should also be understood that certain of these components 202-208 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present invention.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present invention while configured accordingly. Alternatively, as another example, when the processor 202 is embodied as an executor of software instructions, the instructions may specifically configure the processor 202 to perform the algorithms and/or operations described herein when the instructions are executed.

In some embodiments, the apparatus 200 may include input/output circuitry 206 that may, in turn, be in communication with processor 202 to provide output to the user and, in some embodiments, to receive an indication of a user input. The input/output circuitry 206 may comprise a user interface and may include a display, and may comprise a web user interface, a mobile application, a query-initiating computing device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communications circuitry 208 may include the circuitry for interacting with the antenna/antennae to cause transmission of signals via the antenna/antennae or to handle receipt of signals received via the antenna/antennae.

Additionally, or alternatively, in some embodiments, two or more of the sets of circuitries embodying processor 202, memory 204, input/output circuitry 206, and/or communications circuitry 208 are combinable. Alternatively, or additionally, in some embodiments, one or more of the sets of circuitry perform some or all of the functionality described associated with another component. For example, in some embodiments, two or more of the sets of circuitry embodied by processor 202, memory 204, input/output circuitry 206, and communications circuitry 208 are combined into a single module embodied in hardware, software, firmware, and/or a combination thereof. Similarly, in some embodiments, one or more of the sets of circuitry 202-208 is/are combined with the processor 202, such that the processor 202 performs one or more of the operations described above with respect to each of these sets of circuitry.

It is also noted that all or some of the information discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

### Example Client Computing Device

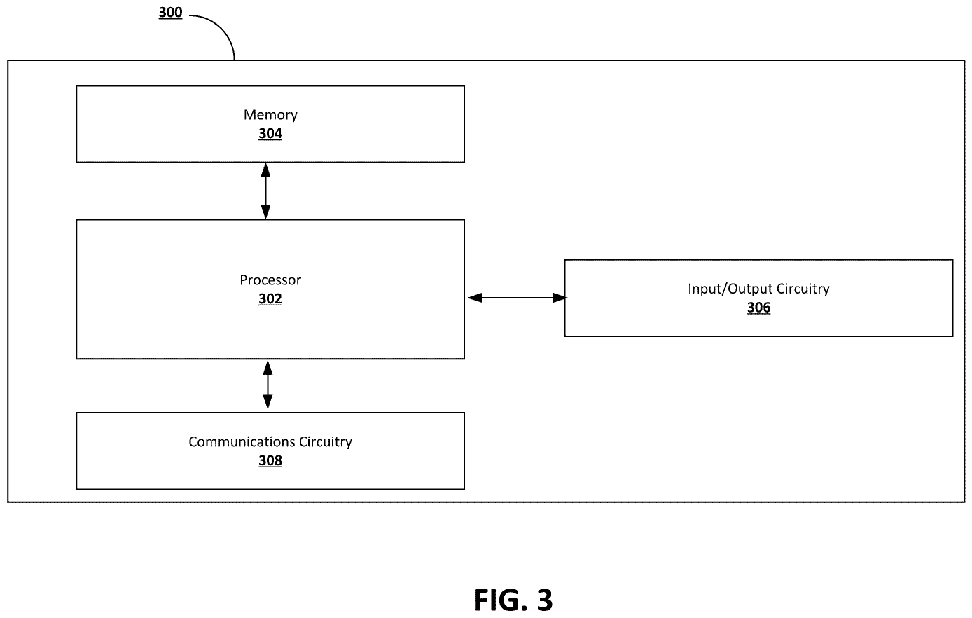

Referring now to FIG. 3, a client computing device may be embodied by one or more computing systems, such as apparatus 300 shown in FIG. 3. The apparatus 300 may include processor 302, memory 304, input/output circuitry 306, and a communications circuitry 308. Although these components 302-308 are described with respect to functional limitations, it should be understood that the particular implementations necessarily include the use of particular hardware. It should also be understood that certain of these components 302-308 may include similar or common hardware. For example, two sets of circuitries may both leverage use of the same processor, network interface, storage medium, or the like to perform their associated functions, such that duplicate hardware is not required for each set of circuitries.

In some embodiments, the processor 302 (and/or co-processor or any other processing circuitry assisting or otherwise associated with the processor) may be in communication with the memory 304 via a bus for passing information among components of the apparatus. The memory 304 is non-transitory and may include, for example, one or more volatile and/or non-volatile memories. In other words, for example, the memory 304 may be an electronic storage device (e.g., a computer-readable storage medium). The memory 304 may include one or more databases. Furthermore, the memory 304 may be configured to store information, data, content, applications, instructions, or the like for enabling the apparatus 300 to carry out various functions in accordance with example embodiments of the present invention.

The processor 302 may be embodied in a number of different ways and may, for example, include one or more processing devices configured to perform independently. In some preferred and non-limiting embodiments, the processor 302 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 302 may be configured to execute instructions stored in the memory 304 or otherwise accessible to the processor 302. In some preferred and non-limiting embodiments, the processor 302 may be configured to execute hard-coded functionalities. As such, whether configured by hardware or software methods, or by a combination thereof, the processor 302 may represent an entity (e.g., physically embodied in circuitry) capable of performing operations according to an embodiment of the present invention while configured accordingly. Alternatively, as another example, when the processor 302 is embodied as an executor of software instructions (e.g., computer program instructions), the instructions may specifically configure the processor 302 to perform the algorithms and/or operations described herein when the instructions are executed.

In some embodiments, the apparatus 300 may include input/output circuitry 306 that may, in turn, be in communication with processor 302 to provide output to the user and, in some embodiments, to receive an indication of a user input. The input/output circuitry 306 may comprise a user interface and may include a display, and may comprise a web user interface, a mobile application, a query-initiating computing device, a kiosk, or the like.

In embodiments in which the apparatus 300 is embodied by a limited interaction device, the input/output circuitry 306 includes a touch screen and does not include, or at least does not operatively engage (i.e., when configured in a tablet mode), other input accessories such as tactile keyboards, track pads, mice, etc. In other embodiments in which the apparatus is embodied by a non-limited interaction device, the input/output circuitry 306 may include at least one of a tactile keyboard (e.g., also referred to herein as keypad), a mouse, a joystick, a touch screen, touch areas, soft keys, and other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 304, and/or the like).

The communications circuitry 308 may be any means such as a device or circuitry embodied in either hardware or a combination of hardware and software that is configured to receive and/or transmit data from/to a network and/or any other device, circuitry, or module in communication with the apparatus 300. In this regard, the communications circuitry 308 may include, for example, a network interface for enabling communications with a wired or wireless communication network. For example, the communications circuitry 308 may include one or more network interface cards, antennae, buses, switches, routers, modems, and supporting hardware and/or software, or any other device suitable for enabling communications via a network. Additionally, or alternatively, the communications circuitry 308 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 300. In some embodiments, one or more external systems (such as a remote cloud computing and/or data storage system) may also be leveraged to provide at least some of the functionality discussed herein.

### Example Data Flows, Operations, and User Interfaces

As indicated, some embodiments of the present disclosure make important technical contributions to issue tracking systems (also referred to issue management systems). The issue tracking system 101, for example, may be configured to enhance the efficiency and consistency of responses in customer support or service management environments. The issue tracking system 101 may leverage a combination of natural language processing, machine learning, and RAG to produce contextually relevant responses. Various embodiments, address challenges commonly faced in conventional issue management/tracking systems, such as time-consuming manual response crafting and inconsistencies in responses across similar issues. Various embodiments, of the present disclosure dynamically and automatically initiates a response generation process.

In some implementations, the issue tracking system 101 may be configured to dynamically suggest generation of response templates and/or suggest previously generated response templates based on the content and context of current issue tickets (e.g., input issue data object associated therewith).

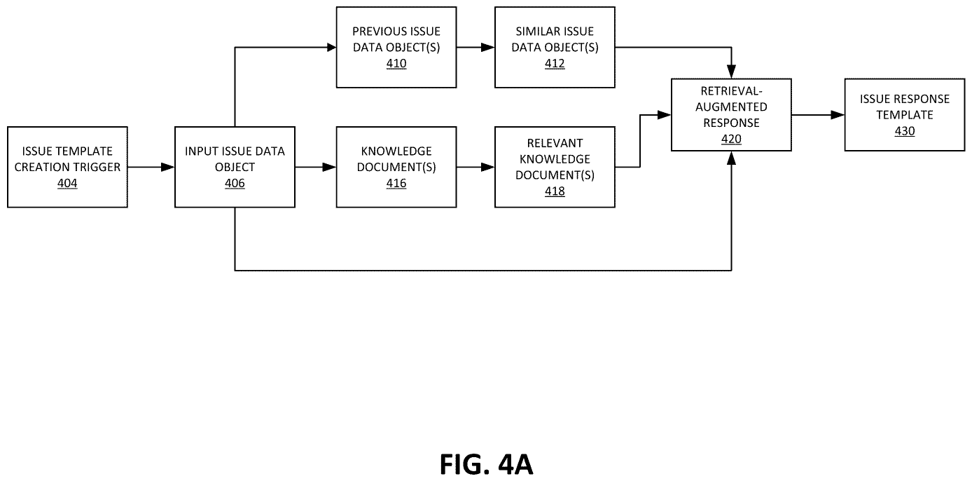

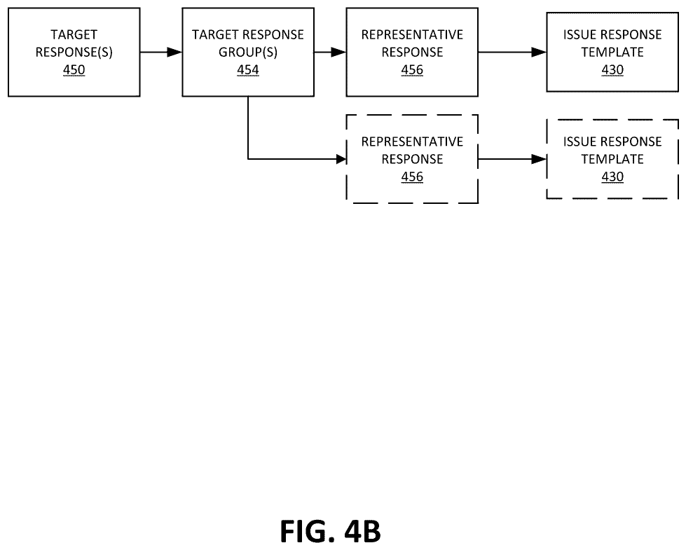

FIG. 4A illustrates a visualization of an example data environment for generating response templates in accordance with at least some embodiments of the present disclosure.

In some embodiments, the issue tracking server computing device 106 receives an issue template creation trigger 404. In some embodiments, the issue tracking server computing device 106 receives the issue template creation trigger 404 from a client computing device 102. In some embodiments, the issue template creation trigger 404 is signal, data, a message (e.g., an inter-service message, intra-service message, network message, etc.), and/or computer readable instructions that invokes or otherwise initiates generation of response template(s) 430 by the issue tracking server computing device 106.

In some embodiments, the issue template creation trigger 404 is a response creation indication associated with an input issue data object 406. In this regard, in some embodiments, receiving the issue template creation trigger 404 comprises the issue tracking server computing device 106 receiving a response creation indication associated with an input issue data object from a client computing device 102. In some embodiments, the issue template creation trigger is a template generation request associated with an input issue data object 406.

In some embodiments, the input issue data object is an issue data object that is associated with a current and/or new issue ticket. For example, an input issue data object may correspond to an issue ticket with respect to which a response is currently being submitted by a user.

In some embodiments, a response creation indication is signal, data, a message (e.g., an inter-service message, intra-service message, network message, etc.), and/or computer readable instructions descriptive of an indication of a response creation event associated with an input issue data object 406. A response creation event may occur when a response is generated in the issue tracking system 101 based on user input comprising the response. For example, a user may provide a response to an issue associated with an input issue data object (e.g., response to a service request, incident alert, and/or the like in an issue ticket) via an issue tracking user interface associated with the issue tracking system 101. In some embodiments, a client application executing on the client computing device 102 may be configured to determine the occurrence of a response creation event and in response to the response creation event, generate and transmit a response creation indication to the issue tracking server computing device 106.

The response creation indication may include an issue identifier associated with the input issue data object 406. In some embodiments, the issue identifier is one or more items or elements by which an issue data object may be uniquely identified from other issue data objects. The issue identifier may be in the form of text string(s), numerical character(s), alphabetical character(s), alphanumeric code(s), American Standard Code for information Interchange (ASCII) characters(s), and/or the like.

In some embodiments, the issue tracking server computing device 106 extracts one or more issue features from the input issue data object 406. In some embodiments, the one or more issue features comprises the issue title, issue description, and/or a comment associated with the issue/issue ticket that is associated with the input issue data object 406.

In some embodiments, the issue tracking server computing device 106 identifies and retrieves one or more similar issue data objects 412 from one or more previous issue data objects 410. For example, the issue tracking server computing device 106 may access a storage location (e.g., storage subsystem 108) storing previous issue data objects maintained by the issue tracking system 101 and identify one or more similar issue data objects 412 from the previous issue data objects stored therein. In some embodiments, the issue tracking server computing device 106 identifies and retrieves the one or more similar issue data objects 412 using a retrieval model and based on the one or more issue features extracted from the input issue data object 406. In some embodiments, the issue tracking server computing device 106, using the retrieval model, may compare a comment feature (e.g., comprising a previous response) the input issue data object 406 to the comment feature of each of one or more previous issue data objects 410 to identify the one or more similar issue data objects 412. Alternatively, or additionally, in some embodiments, the issue tracking server computing device 106, using the retrieval model, may compare an issue title feature of the input issue data object 406 to the issue title feature of each of one or more previous issue data objects 410 to identify the one or similar issue data object(s). In some embodiments, the retrieval model is a component of a retrieval-augmented template generation framework as described herein.

In some embodiments a similar issue data object 412 is a previous issue data object that is similar (e.g., semantically similar, syntactically similar, and/or the like) to the input issue data object 406. A previous issue data object 410 may be identified by the issue tracking server computing device 106 as a similar issue data object 412 with respect to the input issue data object 406 based on a similarity score generated by the issue tracking server computing device 106 for the previous issue data object 410 with respect to the input issue data object 406. In some embodiments, a similar issue data object 412 comprises a previous issue data object 410 associated with a similarity score that satisfies an issue similarity threshold. For example, the issue tracking server computing device 106 may compare similarity scores generated for previous issue data objects 410 with an issue similarity threshold to identify the one or more similar issue data objects 412.

In some embodiments, identifying the one or more similar issue data objects 412 comprises generating an issue similarity score set based on the input issue data object 406 and the one or more previous issue data objects 410, and selecting the one or more similar issue data objects 412 from the one or more previous issue data objects 410 based on the issue similarity score set. Specifically, in some embodiments, the issue tracking server computing device 106 may generate an issue similarity score set comprising one or more issue similarity scores based on the one or more issue features (or portion thereof) extracted from the input issue data object 406 and corresponding one or more issue features (or portion thereof) of each of the one or more previous issue data objects. In some embodiments, the issue tracking server computing device 106 may generate a similarity score in the one or more issue similarity score set by comparing a comment feature of the input issue data object 406 to the comment feature of a previous issue data object. Alternatively, or additionally, in some embodiments, the issue tracking server computing device 106 may generate the similarity score by comparing an issue title feature of the input issue data object 406 to the issue title feature of a previous issue data object 410. In this regard, the issue tracking server computing device 106 may generate the issue similarity score set by comparing the issue features (or subset of the issue features) of the input issue data object 406 to corresponding issue features of previous issue data objects 410. Each issue similarity score in the issue similarity score set may be associated with a particular previous issue data object of the one or more previous issue data objects 410.

In some embodiments, the identified one or more similar issue data objects 412 comprise a selected subset of a plurality of similar issue data objects. For example, in some embodiments, issue tracking server computing device 106 may be configured to select a predetermined number of similar issue data objects based on, for example, configurable parameters. The issue tracking server computing device 106 may be configured to rank the previous issue data objects based on their similarity scores and select the top N issue data objects, where N is an integer. For example, the issue tracking server computing device 106 may be configured to select the top five (5) similar issue data objects, top ten (10) similar issue data objects, or the like.

In some embodiments, an issue similarity score is a value indicating how similar or otherwise a previous issue data object 410 is to the input issue data object 406. An issue similarity score may be calculated based on the one or more issue features (or subset thereof) of the input issue data object 406 and the corresponding one or more input issue features (or subset thereof) of the previous issue data object 410. For example, the closer the feature(s) of a previous issue data object 410 are to the corresponding feature(s) of the input issue data object 406, the more similar the previous issue data object 410 and the input issue data object 406 are likely to be.

An issue similarity score may be calculated using any of various models, functions, and/or techniques. For example, an issue similarity score may be calculated or otherwise generated using any of cosine similarity, Levenshtein distance, Manhattan distance, Euclidean distance, semantic similarity, lemmatized string similarity, term frequency comparison; Jaccard similarity, and/or the like. In some embodiments, the similarity function(s) leveraged to generate the issue similarity scores may be selected based on the data type and/or tailored to the specific characteristics of the data type. For example, the issue tracking server computing device 106 may identify and retrieve the one or more similar issue data objects 412 using a retrieval model that comprises or otherwise leverages the selected similarity function. In some embodiments, the selected similarity function is cosine similarity function.

In some embodiments such as where cosine similarity function is leveraged to generate issue similarity scores, vector representations of the issue feature(s) of the respective issue data objects may be generated and leveraged to generate the issue similarity scores. For example, a cosine similarity function may measure the cosine of the angle between two vectors in a multi-dimensional space, where each dimension represents an issue feature. One or more techniques such as, but not limited to, term frequency-inverse document frequency (TF-IDF) or word embeddings may be leveraged to generate the vector representations which may comprise converting the textual issue features into numerical vectors.

For example, generating an issue similarity score for a previous issue data object 410 with respect to the input issue data object 406 may comprise generating a vector representation of each of the one or more issue features (or subset thereof) of the input issue data object 406 and corresponding one or more issue features (or subset thereof) of the previous issue data object 410, and applying a similarity function (e.g., cosine similarity function or the like) to the vector representations to generate the issue similarity score for the previous issue data object 410. In some embodiments, generating a vector representation of an issue feature of the input issue data object 406 and/or a previous issue data object 410 may comprise identifying relevant words and/or sentences from the issue feature, retrieving and retrieving word vectors from a language model corresponding to the relevant words identified, and summing the retrieved word vectors (or calculated weighted word vector for each identified word vector) to generate the vector representation for the issue feature. In some embodiments, a combination of similarity functions or advanced techniques such as semantic similarity measures based on word embeddings or sentence encoders may leverages to generate issue similarity scores.

In some embodiments, identifying the one or more similar issue data objects 412 comprises identifying a set of similar issue data objects of one or more sets of similar issue data objects stored in the storage location. For example, in some embodiments, the issue tracking server computing device 106 is configured to periodically analyze issue data objects and generate cluster(s) of similar issue data objects and/or assign a newly created issue data object to an existing cluster of similar issue data objects.

In some embodiments, the issue tracking server computing device 106 identifies and retrieves one or more relevant knowledge documents 418 from one or more knowledge documents 416. For example, the issue tracking server computing device 106 may access a storage location (e.g., storage subsystem 108) storing knowledge documents (e.g., enterprise-specific knowledge documents, domain specific knowledge documents, and/or the like) and identify one or more relevant knowledge documents 418 from the knowledge documents 416 stored therein. A knowledge document may comprise textual data, image data, and/or other representation of information that may be leveraged to determine the appropriate response, solution, and/or the like for one or more tasks. In some embodiments, the issue tracking server computing device 106 identifies and retrieves the one or more relevant knowledge documents 418 using a retrieval model and based on the one or more issue features (or portion thereof) extracted from the input issue data object 406 and text segments (or other content) associated with the knowledge documents 416. In some embodiments, the retrieval model is a component of a retrieval-augmented template generation framework as described herein. In some embodiments, the same retrieval model may be leveraged to identify and retrieve the one or more relevant knowledge documents 418 and the one or more similar issue data object. In some embodiments, different retrieval models may be leveraged.

In some embodiments, the identified one or more relevant knowledge documents 418 comprise a selected subset of a plurality of relevant knowledge documents. In some embodiments, issue tracking server computing device 106 may be configured to select a predetermined number of relevant knowledge documents based on, for example, configurable parameters. The issue tracking server computing device 106 may be configured to rank the relevant knowledge documents based on their similarity scores and select the top M relevant knowledge documents (e.g., selected subset of relevant knowledge documents), where M is an integer. For example, the issue tracking server computing device 106 may be configured to select the top five (5) relevant knowledge documents, top ten (10) relevant knowledge documents, or the like.

In some embodiments a relevant knowledge document 418 is a knowledge document 416 that is relevant to the input issue data object 406. For example, a relevant knowledge document may comprise textual data and/or other representation of information determined to be particularly suited for determining the appropriate response, solution, and/or the like for a particular task. For example, one or more relevant knowledge documents may be leveraged to determine the appropriate response to an issue/issue ticket. A knowledge document 416 may be identified by the issue tracking server computing device 106 as a relevant knowledge document 418 with respect to the input issue data object 406 based on a similarity score generated by the issue tracking server computing device 106 for the knowledge document 416 with respect to the input issue data object 406. In this regard, in some embodiments, a relevant knowledge document 418 comprises a knowledge document 416 associated with a similarity score that satisfies a knowledge similarity threshold. Additionally, or alternatively, in some embodiments, the relevant knowledge document 418 comprises a knowledge document 416 previously leveraged by a user (e.g., user of the issue tracking system) to resolve or otherwise respond to previous similar issues.

In some embodiments, identifying the one or more similar issue data objects 412 comprises generating a knowledge similarity score set based on the input issue data object 406 and the one or more knowledge documents 416 and selecting the one or more relevant knowledge documents 418 from the one or more knowledge documents 416 based on the knowledge similarity score set. Specifically, in some embodiments, the issue tracking server computing device 106 may generate a knowledge similarity score set comprising one or more knowledge similarity scores based on the input issue data object 406 and the one or more knowledge documents 416. Each knowledge similarity score in the knowledge similarity score set may be associated with a particular knowledge document of the one or more knowledge documents.

In some embodiments, a knowledge document similarity score is a value indicating how relevant or otherwise a knowledge document 416 is to the input issue data object 406. A knowledge similarity score may be calculated based on one or more issue features of the input issue data object 406 and one or more text segments (e.g., words, sentences, paragraphs, summary section, and/or the like) of the knowledge document. A knowledge similarity score may be calculated using any of various models, functions, and/or techniques. For example, a knowledge similarity score may be calculated or otherwise generated using any of cosine similarity, Levenshtein distance, Manhattan distance, Euclidean distance, semantic similarity, lemmatized string similarity, term frequency comparison; Jaccard similarity, and/or the like.

In some embodiments, the similarity function(s) leveraged to generate the knowledge similarity scores may be selected based on the data type and/or tailored to the specific characteristics of the data type. For example, issue tracking server computing device 106 may identify and retrieve the one or more relevant knowledge documents 418 using a retrieval model that comprises or otherwise leverages the selected similarity function. In some embodiments, the selected knowledge similarity function is a Jaccard similarity function. In some embodiments, the selected knowledge similarity function is a cosine function. In some embodiments, vector representations of the feature(s) of the input issue data object and vector representation of one or more text segments of the knowledge document may be generated and leveraged to generate the knowledge similarity score. In some embodiments, the knowledge document similarity scores may be generated using a combination of similarity functions or advanced techniques such as semantic similarity measures based on word embeddings or sentence encoders may. Such techniques may capture more nuanced relationships between the input issue data object and knowledge documents beyond keyword matching.

In some embodiments, vector representations of the feature(s) of the input issue data object 406 and the text segment(s) of the knowledge document may be generated and leveraged to generate the knowledge similarity score. For example, generating a knowledge similarity score for a knowledge document 416 with respect to the input issue data object 406 may comprise generating a vector representation of each of the one or more issue features (or portion thereof) of the input issue data object 406 and text segment(s) of the knowledge document 416, and applying a similarity function (e.g., a cosine similarity function, Euclidean distance function, and/or the like) to the vector representations to generate the knowledge similarity score for the knowledge document 416.

In some embodiments, the issue tracking server computing device 106 generates a response template 430 based on an input dataset. In some embodiments, the input dataset comprises the input issue data object 406, the one or more similar issue data objects 412, and/or the one or more relevant knowledge documents 418. In some embodiments, the input dataset comprises information extracted from or otherwise determined based on the input issue data object 406, the one or more similar issue data objects 412 and/or the one or more relevant knowledge documents 418.

In some embodiments, the issue tracking server computing device 106 leverages a generative AI model and/or other models associated with the retrieval-augmented template generation framework (as described herein) to generate the response template 430. In some embodiments, generating the response template 430 may comprise inputting the input dataset into a generative AI model and obtaining the response template 430 from the generative AI model.

In some embodiments, inputting the input dataset into the generative AI model comprises generating a retrieval-augmented prompt and providing the retrieval-augmented prompt to the generative AI model. In some embodiments, a retrieval-augmented prompt is an input provided to a model such as a generative AI model to guide the model to generate a contextually relevant output. The retrieval-augmented prompt may be augmented or otherwise include relevant retrieved context data. In some embodiments, the relevant retrieved context data comprise information extracted from or otherwise determined based at least in part on the input issue data object 406, the one or more similar issue data objects 412 and the one or more relevant knowledge documents 418 (e.g., at least a portion thereof).

In some embodiments, generating the response template 430 comprises generating, by the generative AI model and/or other models associated with the retrieval-augmented template generation framework, a retrieval-augmented response 420 based on the input issue data object 406 (e.g., at least a subset of the issue features thereof), the one or more similar issue data objects 412 (e.g., at a subset of the issue features thereof) and/or the one or more relevant knowledge documents 418, and generating the response template 430 based on the retrieval-augmented response 420. In some embodiments, the response template 430 may be generated based on at least the comment feature of the input issue data object 406, the comment feature of one or more similar issue data objects 412 and/or the one or more relevant knowledge documents 418. In some embodiments, generating the response template 430 may be a two-stage process. In this regard, in some embodiments, the retrieval-augmented response 420 may be an intermediate output of a retrieval-augmented template generation framework.

The issue tracking server computing device 106, using the generative AI model, may be configured to analyze and synthesize information from the input issue data object, the one or more similar issue data object(s), and/or one or more relevant knowledge documents to generate the retrieval-augmented response 420. In some embodiments, the retrieval-augmented response 420 may be representative of the issue responses of the issue data objects in an issue data object cluster (e.g., comprising the input issue data object 406 and the similar issue data objects 412) or otherwise generated based at least in part on the issue data object cluster and/or the one or more relevant knowledge documents 418.

In some embodiments, generating the response template 430 comprises modifying, by the generative AI model, the retrieval-augmented response 420 to generate the response template 430 (or a segment thereof). In some embodiments, the response template 430 comprises a preconfigured issue title and a preconfigured response that defines or otherwise includes one or more template variables.

In some embodiments, generating the response template 430 may comprise inputting an input dataset as described above into a generative AI model using a retrieval-augmented prompt; obtaining the retrieval-augmented response 420 from the generative AI model; and inputting the retrieval-augmented response into the generative AI model or a second generative AI model to generates a response template 430.

In some embodiments, the response template is an electronically managed data structure representative of a preconfigured response (e.g., pre-written response). For example, the response template 430 may comprise a preconfigured response that defines or otherwise includes one or more template variables. The response template 430 may be associated with a particular issue type or a group of issue types. For instance, the response template 430 may be configured for being leveraged to respond to issues of a particular issue type. An issue type as described herein may be defined at least in part by the description feature.

In some embodiments, a template variable is a data entity representative of a placeholder for user-specific and/or issue-specific information in a response template. For example, a template variable within a response template may be configured for being modified by the user to, for example, ensure flexibility and reusability of response templates across different users, projects, or support scenarios. The placeholders may be clearly marked within the response template, prompting agents to input relevant details. For example, a placeholder might indicate where a user should insert a customer's name, specific issue details, and/or the like. Non-limiting examples of template variables include current user, issue assignee, issue key, issue reporter, issue resolution, issue summary, portal URL, request status, or request URL. Alternatively, or additionally, in some embodiments, the issue tracking server computing device 106 may be configured to automatically populate the template variables based on information associated with the user prior to providing the response template to the user.

In some embodiments, the issue tracking server computing device 106 stores the response template 430 in a storage location. In some embodiments, the issue tracking server computing devices 106 causes display of the response template in an issue tracking user interface rendered on a client computing device in response to a selection indication corresponding to the response template 430. For instance, the issue tracking server computing device 106 may prompt a user to select from one or more response templates and provide a response template from the one or more response templates that corresponds to the user's selection. The selected response template, for example, may be provided for display to via an issue tracking user interface associated with the issue tracking system 101 as described herein.

In some embodiments, the response template generation process (or portion thereof) described with respect to FIG. 4A may be executed periodically. For example, the issue tracking server computing device 106 may utilize a cron job technique to automate the execution of the response template generation process at regular intervals. A cron job may be a time-based job scheduler that allows the system to perform routine maintenance and updates without manual intervention. In some examples, the cron job may be configured to run daily, weekly, or at any other appropriate frequency depending on the volume of new tickets and the desired update frequency. During each scheduled execution, the response template generation process may analyze issue data objects that have accumulated since the last update.

FIG. 4B illustrates a visualization of an example data environment for generating response templates in accordance with at least some embodiments of the present disclosure. Specifically, FIG. 4B illustrates a visualization of an example data environment for generating response templates based on frequently duplicated responses. For example, the issue tracking server computing device 106 may be configured to identify and analyze previous responses that are frequently copy-pasted by users of the issue tracking system 101 and generate response templates based on the analysis. The analysis may include determining duplication event count associated with the identified responses and comparing the duplication event count to a duplication threshold. In some embodiments, the analysis may include identifying common patterns used by team members (e.g., user) for specific types of issues. For example, if a user frequently copy and paste a specific set of troubleshooting steps for a common login issue, the feature extraction module may identify this pattern and generated a response template comprising these steps including template variables (e.g., placeholders) for user-specific information and/or issue-specific information.

In some embodiments, the issue tracking server computing device 106 identifies a one or more target responses 450 associated with one or more previous issue data objects. In some embodiments, a target response 450 is a previous response that is associated with a duplication event count that satisfies (e.g., exceeds, equal to, or the like) a duplication count threshold. In some embodiments the duplication event count is a value indicating the number of times the previous response was duplicated (e.g., copy-pasted) over a specified time period (e.g., 20 days, 2 days, 4 months, 2 years, or the like).

In some embodiments, the issue tracking server computing device 106 identifies the one or more target responses by determining a duplication event count associated with each of a plurality of previous responses associated with a plurality of previous issue data objects. In some embodiments, the issue tracking server computing device 106 is configured to analyze the comment field of each of the plurality of previous issue data objects to identify and/or extract the one or more target responses.

In some embodiments, previous issue data objects maintained by the issue tracking system 101 are associated with and/or include duplication metadata. For example, the issue tracking server computing device 106 may be configured to detect and track duplication events associated with issue data objects maintained by the issue tracking system 101. In some embodiments, the duplication metadata comprise data, indication, and/or flag that indicates whether the issue data object (e.g., previous response associated with the issue data object) is associated with at least one duplication event. In such some embodiments, identifying and/or extracting the one or more target responses may comprise identifying candidate previous issue response, determining the duplication event count associated with each candidate previous issue response, comparing the respective duplication event count to the duplication count threshold, and selecting the one or more target responses 450 from the candidate previous issue response. In this regard, a candidate previous issue response may be a previous issue response that is associated with at least one duplication event.

Alternatively, or additionally, in some embodiments, the duplication metadata comprise duplication event count data associated with the respective issue data object. In such some embodiments, identifying and/or extracting the one or more target responses 450 may comprise determining the duplication event count associated with each previous issue data object, comparing the respective duplication event count to the duplication count threshold, and selecting the one or more target responses 450 from the previous issue responses.

In some embodiments, the issue tracking server computing device 106 generates one or more target response groups 454 based on the identified one or more target responses 450. In some embodiments, a target response group comprises similar target responses. In some embodiments, the issue tracking server computing device 106 generates the target response group by applying one or more similarity functions to the one or more target response 450. For example, a target response group may comprise target responses 450 that are closest to each other within an embedding space as defined by a similarity function.

In some embodiments, the issue tracking server computing device 106 generates a response template 430 for a target response group 454 and based on a representative response 456 associated with the target response group. For example, a target response from a target response group may be selected as the representative response 456 for the target response group.

In some embodiments, the response template 430 is generated using a generative AI model of the retrieval-augmented template generation framework. In some embodiments, generating the response template comprises modifying, by the generative AI model, the representative response 456 to generate the response template 430 (or a segment thereof). In some embodiments, generating the response template 430 comprises generating a retrieval-augmented prompt that guides the generative AI model to generate the response template 430. In some embodiments, the response template comprises a preconfigured issue title and a preconfigured response that defines or otherwise includes one or more template variables as described.

In some embodiments, the issue tracking server computing device 106 stores the response template 430 in a storage location. In some embodiments, the issue tracking server computing devices 106 causes display of the response template in an issue tracking user interface rendered on a client computing device in response to a selection indication corresponding to the response template 430. For instance, the issue tracking server computing device 106 may prompt a user to select from one or more response templates and provide a response template from the one or more response templates that corresponds to the user's selection. The selected response template, for example, may be provided for display to via an issue tracking user interface associated with the issue tracking system 101 as described herein.

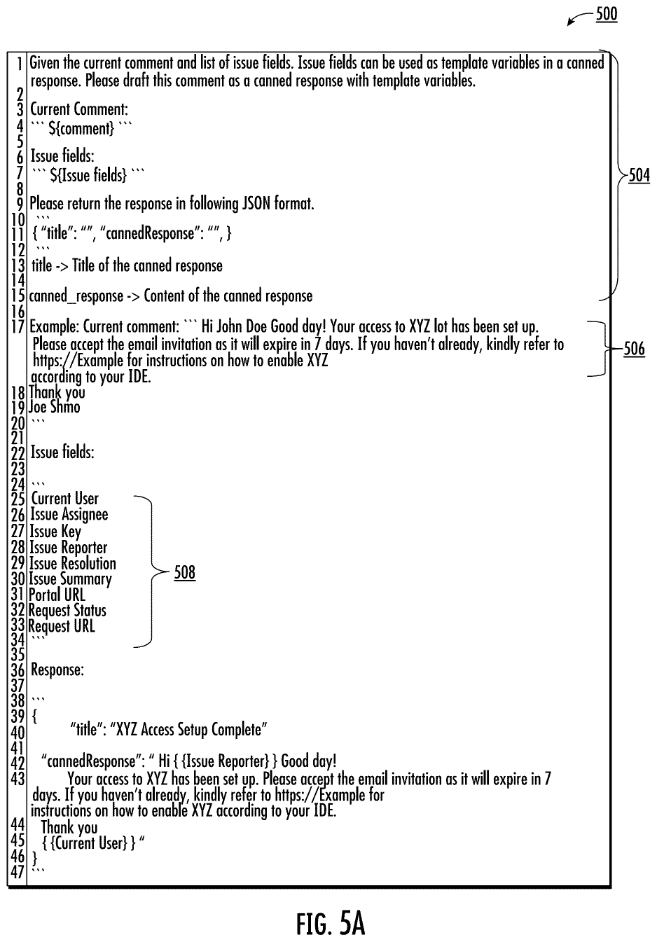

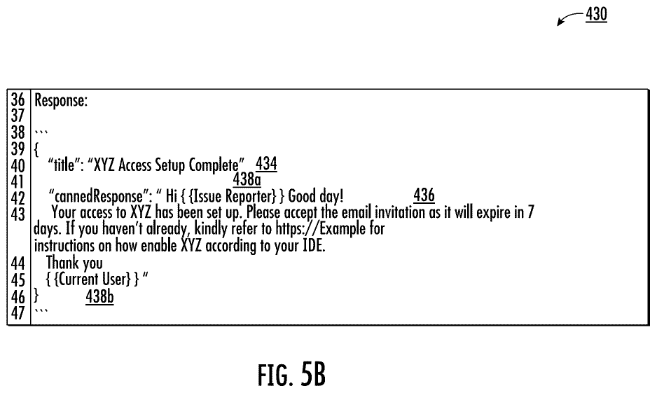

FIG. 5A illustrates an example retrieval-augmented prompt 500 in accordance with at least some embodiments of the present disclosure. FIG. 5B illustrates an example response template 430 in accordance with at least some embodiments of the present disclosure. As shown in FIG. 5A, in the depicted example, the retrieval-augmented prompt 500 comprises an instruction section 504 that provides specific instructions that guides the generative AI model to generate a response template with the appropriate format. The instruction section 504 of the example retrieval-augmented prompt 500, for example, instructs the generative AI model to use the listed “issue fields” 508 as the template variables and to generate, based on a “current comment” provided and the “issue fields” a response template (e.g., canned response) that includes template variables. The instruction section 504 of the example of FIG. 5A further provides instruction relating to the format in which the response template should be generated or otherwise outputted by the generative AI model. As further shown in FIG. 5A, the example retrieval-augmented prompt 500 includes a retrieval-augmented prompt example to further guide the generative AI model to generate an appropriate response template 506.

As depicted in FIG. 5B, the example response template 430 comprises a preconfigured issue title 434 and a preconfigured response 436 that includes one or more template variables 438a and 438b.

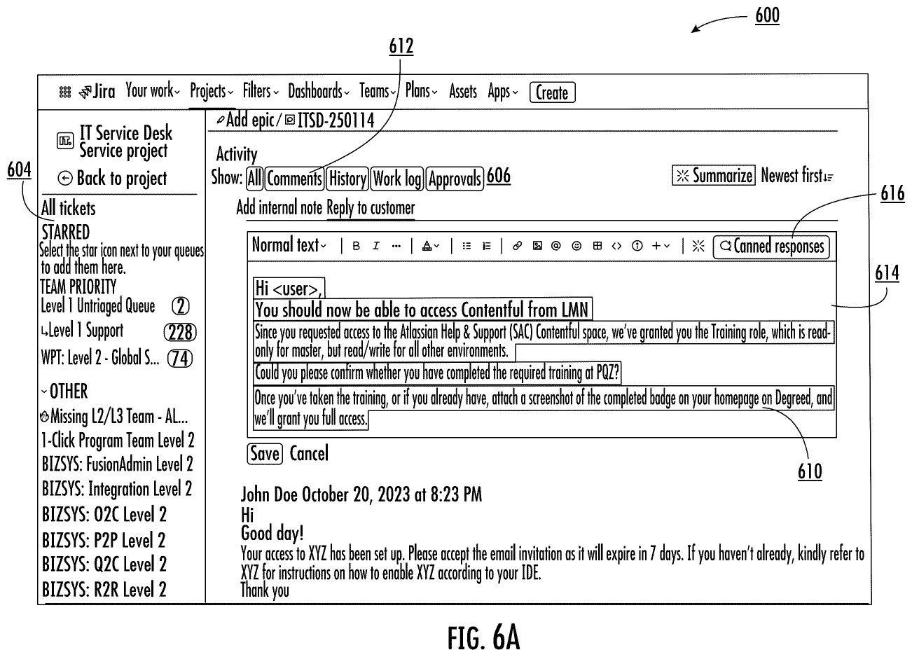

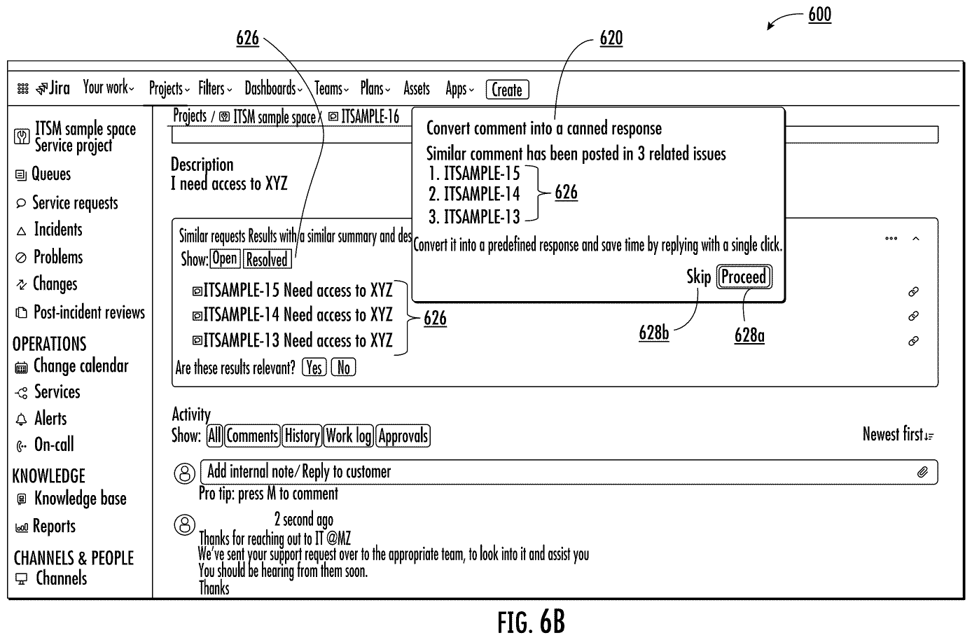

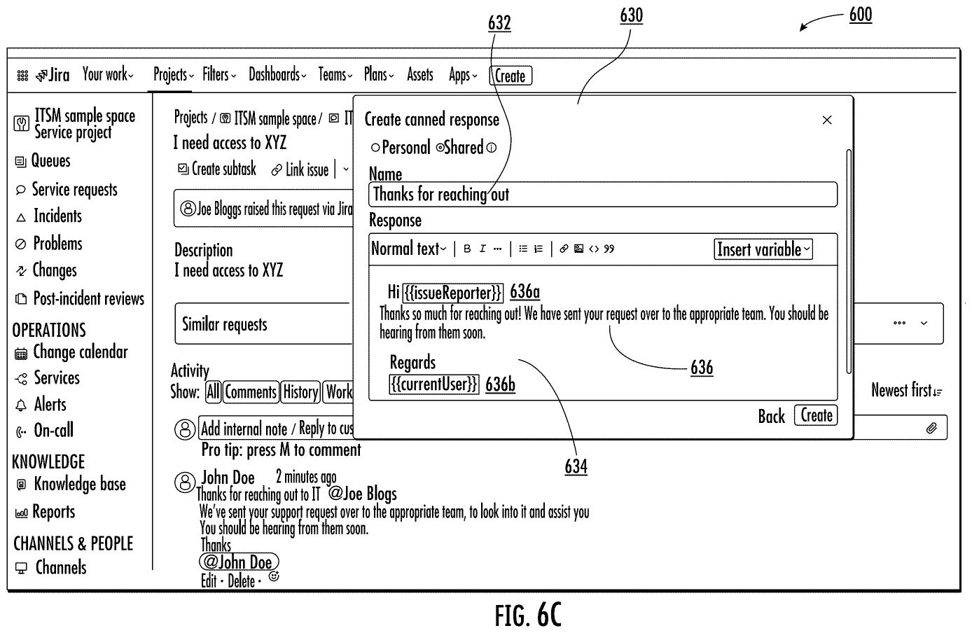

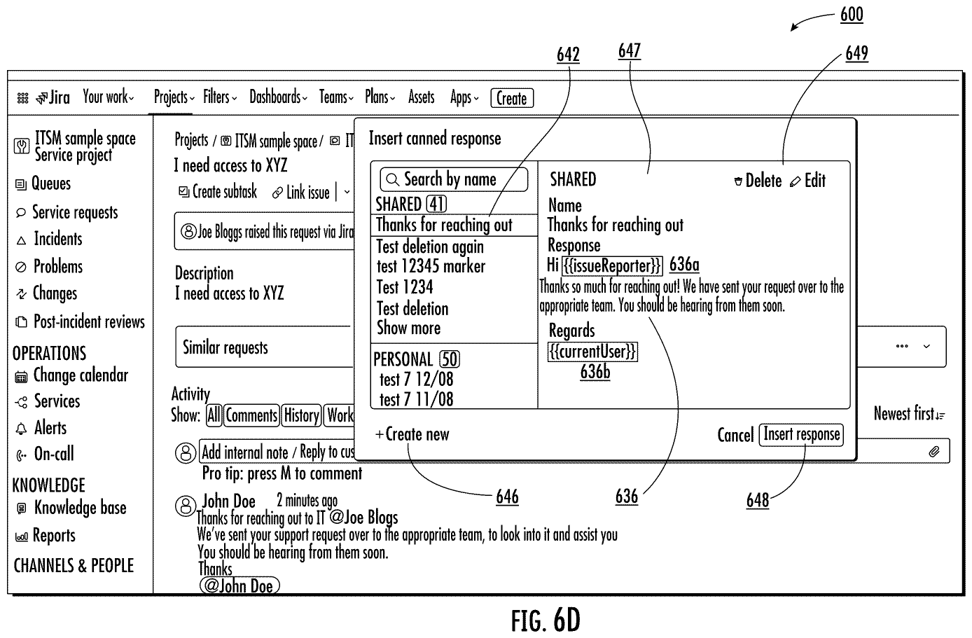

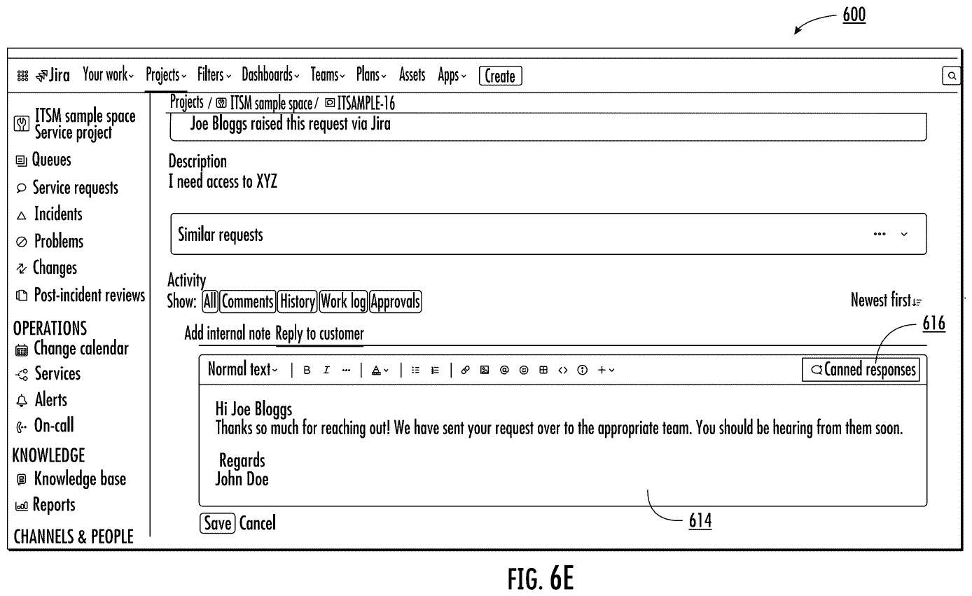

FIGS. 6A-E each depict at least a partial view of example issue tracking user interface 600 configured in accordance with at least some embodiments of the present disclosure. The issue tracking user interface 600 may be, for example, an electronic interface (e.g., graphical user interface) of a client device such as client computing device 102. The issue tracking user interface 600 may include a selectable menu 604. In the illustrated example issue tracking user interface 600, the menu 604 is positioned at the left side of the issue tracking user interface 600. However, it would be appreciated that the menu 604 may be positioned somewhere else within the issue tracking user interface 600. The menu 604 may be configured to facilitate selection of an issue (e.g., visualization of an issue or portion thereof) on the issue tracking user interface 600. The issue tracking user interface 600 may include a comment interface element 612 selectable from a menu 606. The comment interface element 612 may be configured to facilitate rendering of a response interface component 614. The response interface component 614 may be configured to receive user input representative of a response to the selected issue. For example, the response interface component 614 may be configured to allow a user to input (e.g., manually input) a response (such as response 610) to a selected issue via the issue tracking user interface 600. The issue tracking user interface 600 may include a response interface element 616 (e.g., canned response interface element). The response interface element 616 may be configured to facilitate rendering of a template selection interface element 640 as shown in FIG. 6D.

As shown in FIG. 6B, the issue tracking user interface 600 may cause rendering of a template generation interface component 620 (e.g., widget). The template generation interface component 620 may be rendered in response to an issue template creation trigger as described above. The template generation interface component 620 may include a notification and/or authorization request to generate a response template based at least in part on the response 610 associated with the current issue (e.g., input by the user). The template generation interface component 620 may display a list of issue identifiers 626 associated with similar issue data objects identified by the issue tracking system 101. The template generation interface component 620 may include an approval interface elements 628a (e.g., “proceed” button) and/or a reject interface element 628b (e.g., “skip” button). The template generation interface component 620 may include a similar request interface view that displays a list (e.g., selectable list) of the issue identifiers 626.

As shown in FIG. 6C, the issue tracking user interface 600 may cause rendering of a response template interface component 630. The response template interface component 630 may be configured to display the generated response template. As shown in FIG. 6C, the response template interface component 630 may include a name field 632 configured to display the preconfigured title of the generated response template, and a response field 634 configured to display the preconfigured response of the generated response template. As shown in FIG. 6C, the preconfigured response 636 may include one or more template variables such as template variables 636a and 636b.

As shown in FIG. 6C, the issue tracking user interface 600 may cause rendering of a response template interface component 630. The response template interface component 630 may be configured to display the generated response template. As shown in FIG. 6C, the response template interface component 630 may include a name field 632 configured to display the preconfigured title of the generated response template, and a response field configured to display the preconfigured response of the generated response template. As shown in FIG. 6C, the preconfigured response 636 may include one or more template variables such as template variables 636a and 636b.

As described above, a response interface element 616 of the issue tracking user interface 600 may be configured to facilitate rendering of a template selection interface element 640. The template selection interface element 640 may be rendered in response to selection of the response interface element 616. As shown in FIG. 6D. the template selection interface element 640 may include a list view 642 configured to display a list of available response templates. In some examples, the list view 642 may be a scrollable interface component. As further shown in FIG. 6D. the template selection interface element 640 may include a response template view 647 configured to display a selected response template from the list view 642. The template selection interface element 640 may include a template creation interface element 646. The template creation interface element 646 may be configured to facilitate initiation of a template generation process, as described herein. The template selection interface element 640 may include one or more interface elements 649 (e.g., edit button, delete button, and/or the like) configured to facilitate editing and/or deleting of a selected response template. As shown in FIG. 6D, the template selection interface element 640 may include an insert interface element 648 configured to facilitate display of the selected response template on the response interface component 614, as shown in FIG. 6E. As shown in FIG. 6E, the issue tracking system 101 may automatically populate the template variables (e.g., template variables 636a and 636b).

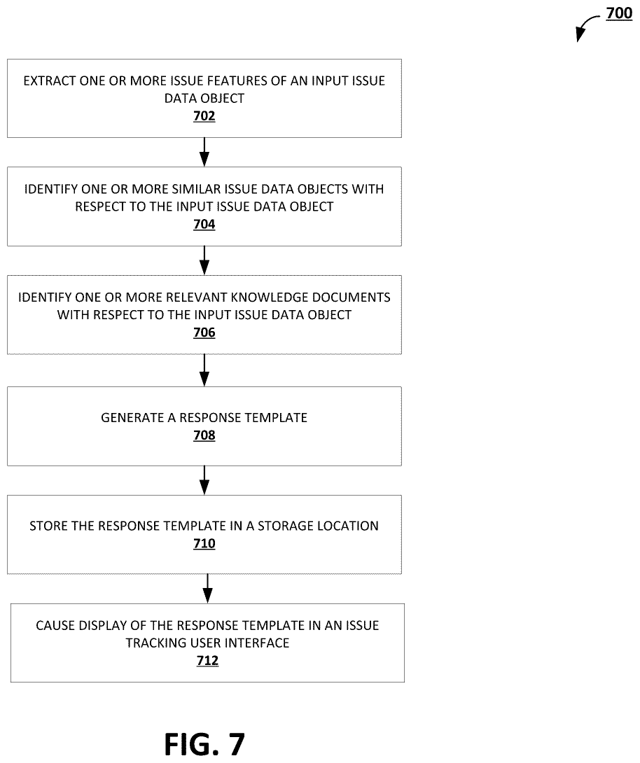

FIG. 7 is a flowchart diagram of an example process 700 for generating response templates in accordance with at least some embodiments of the present disclosure. The process 700 may be implemented by one or more computing devices, apparatuses, entities, and/or systems described herein. For example, the process 800 may be a computer-implemented method. FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 includes at step/operation 702, extracting one or more issue features of an input issue data object. For example, the apparatus 200 may extract one or more issue features in response to a response creation indication associated with the input issue data object.

In some embodiments, the process 700 includes at step/operation 704, identifying one or more similar issue data objects from one or more previous issue data objects. For example, the apparatus 200 may identify one or more similar issue data objects with respect to the input issue data object based on the one or more issue features. In some embodiments, identifying the one or more similar issue data objects comprises the apparatus 200 generating an issue similarity score set based on the input issue data object and the one or more previous issue data objects by applying a similarity function to the input issue data object and the one or more previous issue data objects, and selecting the one or more similar issue data objects from the one or more previous issue data objects based on the issue similarity score set.

In some embodiments, the process 700 includes at step/operation 706, identifying one or more relevant knowledge documents from one or more knowledge documents based on the one or more issue features. For example, the apparatus 200 may identify one or more relevant knowledge documents with respect to the input issue data object based on the one or more issue features and the one or more knowledge documents. In some embodiments, identifying the one or more relevant knowledge documents comprises the apparatus 200 generating a knowledge similarity score set based on the input issue data object and the one or more knowledge documents by applying a similarity function to the input issue data object and the one or more knowledge documents, and selecting the one or more relevant knowledge documents from the one or more knowledge documents based on the knowledge similarity score set.

In some embodiments, the process 700 includes at step/operation 708, generating a response template. For example, the apparatus 200 may generate a response template using a generative AI model and based on the input issue data object, the one or more similar issue data objects, and/or the one or more relevant knowledge documents. In some embodiments, the response template comprises a preconfigured issue title and a preconfigured issue response.

In some embodiments, generating the response template comprises the apparatus 200 generating a retrieval-augmented response based on the input issue data object, the one or more similar issue data objects, and the one or more relevant knowledge documents and generating the response template based on the retrieval-augmented response and the one or more template variables. In some embodiments, generating the response template comprises the apparatus 200 identifying the one or more template variables from a plurality of template variables, and modifying the retrieval-augmented response to include the one or more template variables. In some embodiments, generating the response template comprises the apparatus generating a retrieval-augmented prompt comprising the retrieval-augmented response and at least the one or more template variables, and inputting the retrieval-augmented prompt into the generative AI model.

In some embodiments, the process 700 includes at step/operation 710, storing the response template in a storage location. For example, the apparatus 200 may store the response template in a storage location associated with an issue tracking system.

In some embodiments, the process 700 includes at step/operation 712, causing display of the response template in an issue tracking user interface rendered on a user computing device (e.g., client computing device). For example, the apparatus 200 may cause display of the response template in an issue tracking user interface rendered on a user computing device in response to user input that indicates a selection of the response template from one or more response templates. In some embodiments, displaying the response template comprises, the apparatus 200 populating (e.g., automatically populating) one or more template variables associated with the response template. In some embodiments, causing display of the response template in the issue tracking user interface comprises the apparatus 200 receiving a template request indication via the issue tracking user interface, rendering a template selection interface comprising the one or more response templates, and retrieving the response template from the storage location in response to the user input indicating the response template.

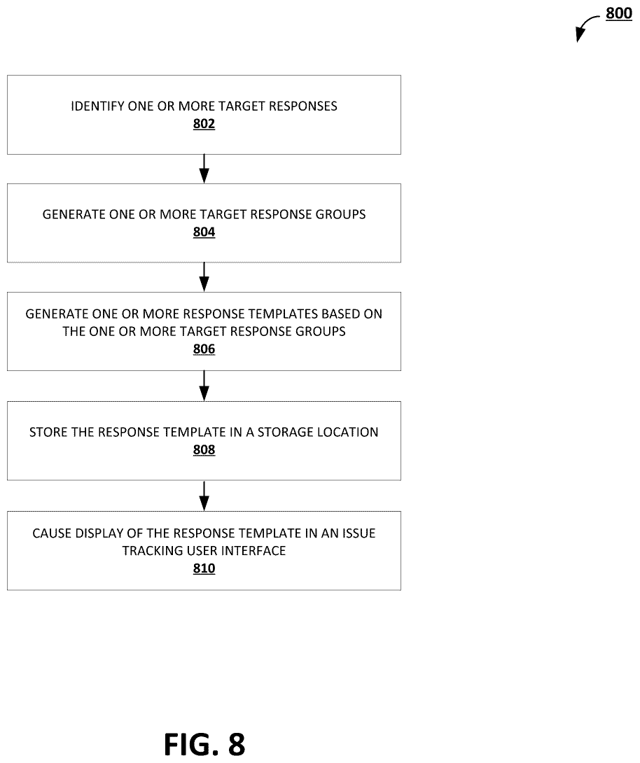

FIG. 8 is a flowchart diagram of an example process 800 for generating response templates in accordance with at least some embodiments of the present disclosure. The process 800 may be implemented by one or more computing devices, apparatuses, entities, and/or systems described herein. For example, the process 800 may be a computer-implemented method. FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In other examples, different components of an example device or system that implements the process 800 may perform functions at substantially the same time or in a specific sequence.

In some embodiments, the process 800 includes at step/operation 802, identifying one or more target responses. For example, the apparatus 200 may identify one or more target responses associated with a plurality of previous issue responses based one or more duplication events associated with the plurality of previous issue responses. In some embodiments, identifying the one or more target responses comprises the apparatus 200 determining a duplication event count associated with each previous issue response of the plurality of previous issue responses, and comparing each previous duplication event count to a duplication threshold, wherein each target response of the one or more target responses satisfies the duplication threshold.

In some embodiments, the process 800 includes at step/operation 804, generating one or more target response groups. For example, the apparatus 200 may generate one or more target response groups based on the one or more target responses by applying a similarity function to the one or more target responses.

In some embodiments, the process 800 includes at step/operation 806, generating a response template. For example, the apparatus 200 may generate a response template using a generative AI model and based on a representative response associated with a target response group of the one or more target response groups. In some embodiments, the response template comprises a preconfigured issue title and a preconfigured issue response. In some embodiments, generating the response template comprises the apparatus 200 identifying the one or more template variables from a plurality of template variables, and modifying the representative response to include the one or more template variables. In some embodiments, generating the response template comprises the apparatus 200 generating a retrieval-augmented prompt comprising the representative response and at least the one or more template variables, and inputting the retrieval-augmented prompt into the generative AI model.

In some embodiments, the process 800 includes at step/operation 808, storing the response template in a storage location. For example, the apparatus 200 may store the response template in a storage location for access by one or more client computing devices.

In some embodiments, the process 800 includes at step/operation 810, causing display of the response template in an issue tracking user interface rendered on a user computing device in response to user input indicating a selection of the response template from one or more response templates, wherein displaying the response template comprises populating one or more template variables associated with the response template. In some embodiments, displaying the response template comprises the apparatus 200 populating one or more template variables associated with the response template.

In some embodiments, causing display of the response template in the issue tracking user interface comprises receiving a template request indication via the issue tracking user interface, rendering a template selection interface comprising the one or more response templates; and, retrieving the response template from the storage location in response to the user input indicating the response template.

### Conclusion

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. A computer-implemented method for retrieval-augmented template generation, the computer-implemented method comprising:
extracting one or more issue features of an input issue data object in response to a response creation indication associated with the input issue data object;
identifying one or more similar issue data objects from one or more previous issue data objects based on the one or more issue features;
identifying one or more relevant knowledge documents from one or more knowledge documents based on the one or more issue features;
generating a response template using a generative AI model and based on the input issue data object, the one or more similar issue data objects, and the one or more relevant knowledge documents, wherein the response template comprises a preconfigured issue title and a preconfigured issue response; and
causing display of the response template in an issue tracking user interface rendered on a user computing device in response to user input indicating a selection of the response template from one or more response templates, wherein displaying the response template comprises populating one or more template variables associated with the response template.

2. The computer-implemented method of claim 1, wherein generating the response template comprises:
generating a retrieval-augmented response based on the input issue data object, the one or more similar issue data objects, and the one or more relevant knowledge documents; and
generating the response template based on the retrieval-augmented response and the one or more template variables.

3. The computer-implemented method of claim 2, wherein generating the response template comprises:
identifying the one or more template variables from a plurality of template variables; and
modifying the retrieval-augmented response to include the one or more template variables.

4. The computer-implemented method of claim 2, wherein generating the response template comprises:
generating a retrieval-augmented prompt comprising the retrieval-augmented response and at least the one or more template variables; and
inputting the retrieval-augmented prompt into the generative AI model.

5. The computer-implemented method of claim 1, further comprising storing the response template in a storage location.

6. The computer-implemented method of claim 5, wherein causing display of the response template in the issue tracking user interface comprises:
receiving a template request indication via the issue tracking user interface;
rendering a template selection interface comprising the one or more response templates; and
retrieving the response template from the storage location in response to the user input indicating the response template.

7. The computer-implemented method of claim 1, wherein identifying the one or more similar issue data objects comprises:
generating an issue similarity score set based on the input issue data object and the one or more previous issue data objects by applying a similarity function to the input issue data object and the one or more previous issue data objects; and
selecting the one or more similar issue data objects from the one or more previous issue data objects based on the issue similarity score set.

8. The computer-implemented method of claim 1, wherein identifying the one or more relevant knowledge documents comprises:
generating a knowledge similarity score set based on the input issue data object and the one or more knowledge documents by applying a similarity function to the input issue data object and the one or more knowledge documents; and
selecting the one or more relevant knowledge documents from the one or more knowledge documents based on the knowledge similarity score set.

9. An apparatus for retrieval-augmented template generation, the apparatus comprising at least one processor and at least one memory including program code, the at least one memory and the program code configured to, with the at least one processor, cause the apparatus to at least:
identify one or more similar issue data objects from one or more previous issue data objects based on one or more issue features associated with an input issue data object;
identify one or more relevant knowledge documents from one or more knowledge documents based on the one or more issue features;
generate a response template using a generative AI model and based on the input issue data object, the one or more similar issue data objects, and the one or more relevant knowledge documents, wherein the response template comprises a preconfigured issue title and a preconfigured issue response; and
cause display of the response template in an issue tracking user interface rendered on a user computing device in response to user input indicating a selection of the response template from one or more response templates, wherein displaying the response template comprises populating one or more template variables associated with the response template.

10. The apparatus of claim 9, wherein generating the response template comprises:
generating a retrieval-augmented response based on the input issue data object, the one or more similar issue data objects, and the one or more relevant knowledge documents; and
generating the response template based on the retrieval-augmented response and the one or more template variables.

11. The apparatus of claim 10, wherein generating the response template comprises:
identifying the one or more template variables from a plurality of template variables; and
modifying the retrieval-augmented response to include the one or more template variables.

12. The apparatus of claim 10, wherein generating the response template comprises:
generating a retrieval-augmented prompt comprising at least (i) one or more prompt example and (ii) the one or more template variables; and
inputting the retrieval-augmented prompt into the generative AI model.

13. The apparatus of claim 9, wherein the at least one memory and the program code configured to, with the at least one processor, further cause the apparatus to at least:
store the response template in a storage location for access by one or more client computing devices.

14. The apparatus of claim 13, wherein cause display of the response template in the issue tracking user interface comprises:
receiving a template request indication via the issue tracking user interface;
rendering a template selection interface comprising the one or more response templates; and
retrieving the response template from the storage location in response to the user input indicating the response template.

15. The apparatus for claim 9, wherein identify the one or more similar issue data objects comprises:
generating an issue similarity score set based on the input issue data object and the one or more previous issue data objects by applying a similarity function to the input issue data object and the one or more previous issue data objects; and
selecting the one or more similar issue data objects from the one or more previous issue data objects based on the issue similarity score set.

16. The apparatus of claim 9, wherein identify the one or more relevant knowledge documents comprises:
generating a knowledge similarity score set based on the input issue data object and the one or more knowledge documents by applying a similarity function to the input issue data object and the one or more knowledge documents; and
selecting the one or more relevant knowledge documents from the one or more knowledge documents based on the knowledge similarity score set.

17. At least one non-transitory computer-readable storage medium for retrieval-augmented template generation, the at least one non-transitory computer-readable storage medium having computer coded instructions configured to, when executed by at least one processor:
identify one or more target responses associated with a plurality of previous issue responses based one or more duplication events associated with the plurality of previous issue responses;
generate one or more target response groups based on the one or more target responses by applying a similarity function to the one or more target responses; and
generate a response template using a generative AI model and based on a representative response associated with a target response group of the one or more target response groups, wherein the response template comprises a preconfigured issue title and a preconfigured issue response; and
store the response template in a storage location for access by one or more client computing devices.

18. The at least one non-transitory computer-readable storage medium of claim 17, wherein identify the one or more target responses comprises:
determining a duplication event count associated with each previous issue response of the plurality of previous issue responses; and
comparing each previous duplication event count to a duplication threshold, wherein each target response of the one or more target responses satisfies the duplication threshold.

19. The at least one non-transitory computer-readable storage medium of claim 17, wherein generate the response template comprises:
modifying the representative response to include one or more template variables.

20. The at least one non-transitory computer-readable storage medium of claim 18, wherein generate the response template comprises:
generating a retrieval-augmented prompt comprising at least (i) one or more prompt example and (ii) one or more template variables; and
inputting the retrieval-augmented prompt into the generative AI model.
